(19) United States
(12) Patent Application Publication
(10) Pub. No.: US 2024/0341233 A1
(43) Pub. Date: Oct. 17, 2024

(54) CONVEYOR DEVICE FOR TRANSPORTING MATERIAL FROM AN OUTDOOR POWER EQUIPMENT

(71) Applicant: MTD PRODUCTS INC, Valley City, OH (US)

(72) Inventors: Jay Maggard, Polk, OH (US); Axel Schaedler, Olmsted Township, OH (US)

(21) Appl. No.: 18/638,129

(22) Filed: Apr. 17, 2024

Related U.S. Application Data
(60) Provisional application No. 63/459,872, filed on Apr. 17, 2023.
(60) Provisional application No. 63/553,451, filed on Feb. 14, 2024.

(51) Int. Cl. A01D 43/077; A01D 43/063; A01D 69/02; A01D 101/00

(52) U.S. Cl. CPC A01D 43/077; A01D 43/063; A01D 69/02; A01D 2101/00

(57) ABSTRACT

A conveyor apparatus can be (removably) secured to a turf maintenance machine and efficiently transport turf clippings out from a mowing implement of the turf maintenance apparatus. An opening in the conveyor apparatus defines an input that is positioned adjacent to a discharge port of a mow deck when secured to the turf maintenance machine. The input therefore receives turf clippings ejected by the turf maintenance machine. A driven element within the conveyor apparatus propels the turf clippings along an interior length to an output. The conveyor apparatus can be operable with a bagging mode of the turf maintenance machine, and can be removed and replaced with a discharge chute to implement a side discharge mode for the turf maintenance machine.

### CROSS-REFERENCE TO RELATED APPLICATIONS

This application claims the benefit of priority from U.S. Provisional Application Nos. 63/459,872, filed Apr. 17, 2023 titled CONVEYOR DEVICE FOR TRANSPORTING MATERIAL FROM A TURF MAINTENANCE MACHINE, and 63/553,451, filed Feb. 14, 2024 titled CONVEYOR DEVICE FOR TRANSPORTING MATERIAL FROM AN OUTDOOR POWER EQUIPMENT, the disclosures of which are hereby incorporated by reference herein in their respective entireties and for all purposes.

### FIELD OF DISCLOSURE

The disclosed subject matter pertains to apparatuses and methods for an outdoor power equipment, for instance, an apparatus for transporting material from the outdoor power equipment, such as turf clippings from a mowing implement of a turf maintenance machine.

### BACKGROUND

Manufacturers of power equipment for outdoor maintenance applications offer many types of machines for general maintenance and mowing applications. These machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Modern maintenance machines also offer multiple options for a power source. The various advantages associated with electric motor engines, gasoline engines, natural gas engines, diesel engines and so forth also impact the mechanical design and engineering that go into these different maintenance devices. Meeting the various challenges associated with different maintenance and mowing applications and the benefits and limitations of different power sources results in a large variety of maintenance machines to meet consumer preferences.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Embodiments of the present disclosure provide a turf maintenance apparatus with a conveyor apparatus for transporting turf clippings out from a mowing implement of the turf maintenance apparatus. In some embodiments, the turf maintenance apparatus can have an electric motor as a prime mover, or an electric motor for powering the mowing implement, or a combination of the foregoing. The subject disclosure is not so limited, however, and other prime movers and implement power sources are within the scope of the present disclosure, such as a combustion engine, hydraulic motor, pneumatic motor, or the like. In one or more aspects of the disclosed embodiments, the conveyor apparatus can be powered by an electric motor.

In one or more additional embodiments, disclosed is a conveyance apparatus coupled to a turf mowing machine. The conveyance apparatus can comprise an implement that drives one or more actuators within a housing from an intake to an output of the conveyance apparatus. Matter, such as turf clippings, loose vegetation, dirt, leaves, etc. received at the conveyance apparatus at the intake port is driven by the actuator(s) from the input port to the output port to eject the matter from the conveyance apparatus. In some embodiments, the output port can be mechanically coupled to a receptacle, bag, or the like to store the matter, or coupled to a material ejector that can eject material received from the output port to a receptacle, bag, or the like to store the matter. The implement can be powered by an electric motor secured to the turf mowing machine or secured to the conveyance apparatus in various embodiments, or a source of mechanical power (e.g., rotation, etc.) on the turf mowing machine (e.g., rotation of a mow spindle, etc.).

In one or more embodiments, disclosed is an apparatus, comprising: a housing that defines an exterior surface of at least a portion of the apparatus; an intake interface of the housing that defines an opening in the housing and is shaped to abut a discharge port of a mow deck of a mowing machine; a fastener configured to mechanically couple the apparatus to the mowing machine to resist movement of the opening away from the ejection port; a driven element configured to be driven to move within the housing, the driven element extending from the intake interface of the housing to an output of the housing and wherein the driven element moves about an axis that is non-parallel with a line between the intake interface of the housing and the output of the housing; a surface adjacent to the driven element and extending from a first end proximate to the opening in the housing to a second end proximate to the output of the housing; and at least one actuator secured to the driven element and movable in conjunction with the driven element relative to the surface, wherein each actuator of the at least one actuator has an associated length that extends partway between the driven element and the surface, and wherein the at least one actuator is configured to transfer momentum from the at least one actuator to material within the housing in response to movement of the driven element within the housing.

In still further embodiments of the present disclosure, provided is a turf maintenance apparatus, comprising: a mow deck comprising a cutting unit for cutting vegetation beneath the mow deck, the mow deck defining an ejection port from which turf clippings generated by the cutting unit are expelled from the mow deck; and a conveyor apparatus having an intake port in fluid communication with the ejection port of the mow deck, wherein turf clippings expelled from the ejection port of the mow deck enter the intake port of the conveyor apparatus, and wherein the conveyor apparatus further comprises: a housing defining exterior surfaces including a deck-side surface in which the intake port defines an opening, wherein the intake port is proximate to a first longitudinal end of the housing; an output port proximate to a second longitudinal end of the housing; a bottom surface of the housing underlying the intake port and defining a bottom surface length extending from the intake port to the output port of the housing; a motor and a motor drive that provides mechanical power in response to operation of the motor; and a powered element and at least one actuator configured to rotate about an axis of rotation in response to the mechanical power provided by the motor and the motor drive, wherein the powered element causes the at least one actuator to traverse the bottom surface at least partway along the length thereof in a direction from the intake port to the output port.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 provides an image of an example conveyor apparatus coupled to a mowing machine according to one or more aspects of the disclosed embodiments;

FIG. 1A depicts an image of the example conveyor apparatus from a side perspective view in further aspects;

FIG. 2 illustrates an image of the conveyor apparatus from a front perspective view;

FIG. 3 provides a drawing of an example conveyor apparatus coupled to an output port of a mow deck of a mowing machine, in an aspect(s);

FIG. 4 depicts a drawing of a deck-side view of a disclosed conveyor apparatus according to one or more additional aspects of the present embodiments;

FIG. 4A illustrates a close-up perspective view of a front portion of a conveyor apparatus still other aspects of the disclosed embodiments;

FIG. 4B depicts a close-up transparent view of the front portion of the conveyor apparatus and an actuator guide rear surface therein, in an aspect(s);

FIG. 5 illustrates a front side view of an example conveyor apparatus in yet other aspects of the present disclosure;

FIG. 6 depicts an exterior side perspective view of an example conveyor apparatus in still additional aspects of the disclosed embodiments;

FIGS. 7A and 7B depict a mow deck with a side discharge opening in further disclosed embodiments;

FIGS. 8A and 8B illustrate a mow deck with a rearward-directed discharge opening according to additional disclosed embodiments;

FIG. 9 depicts a mow deck with a detachable front-edge baffle for implementing a rearward-directed discharge opening according to yet other aspects of the disclosure;

FIG. 10 illustrates a mow deck with a detachable front-edge baffle according to still further aspects disclosed herein;

FIG. 10A depicts an example rearward discharge deck coupler for directing material discharged from a rearward discharge mow deck to a front intake conveyor apparatus;

FIG. 10B illustrates the example rearward discharge deck coupler from a bottom front perspective showing the coupler output and conveyor intake interface;

FIGS. 11A and 11B illustrate a front image and a bottom front image, respectively, of an example front intake conveyor apparatus, according to other aspects;

FIG. 12 illustrates an example material ejector for a conveyor system according to various aspects disclosed herein;

FIG. 13 depicts an output view and an input view of the interior of the example ejector housing of FIG. 12 in one or more aspects of the disclosed embodiments;

FIG. 14 shows a receptacle hood coupled to the elevated hood ejector housing and trajectory of turf clippings expelled from the ejector housing;

FIG. 15 illustrates a rear view of an example mowing apparatus comprising a conveyor apparatus and bagging system, according to aspects discussed herein;

FIG. 16 depicts a rear view of a bagging system and conveyor ejection apparatus driven by motor, belt and multiple pulley apparatus, in one or more aspects;

FIG. 17 illustrates a top view of an example conveyor system comprising a material ejector employing passive material redirection, according to various aspects herein.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to transporting turf clippings from a mow deck of power equipment machines are described herein, it should be understood that the disclosed machines, electronic and computing devices and methods are not so limited and modifications may be made without departing from the scope of the present disclosure. The scope of the devices, components of such devices, coupling apparatuses and power sources are defined by the appended claims, and all devices, components, and apparatuses that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” “turf maintenance machine” and “power equipment machine” are used interchangeably and are intended to refer to any of robotic, partially robotic ride-on, manually operated ride-on, walk-behind, sulky equipped, autonomous, semi-autonomous (e.g., user-assisted automation), remote control, or multi-function variants of any of the following: powered carts and wheel barrows, motorized or non-motorized trailers, lawn mowers, lawn and garden tractors, cars, trucks, go-karts, scooters, buggies, powered four-wheel riding devices, powered three-wheel riding devices, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn or leaf vacuums, pressure washers, lawn equipment, garden equipment, driveway sprayers and spreaders, and sports field marking equipment.

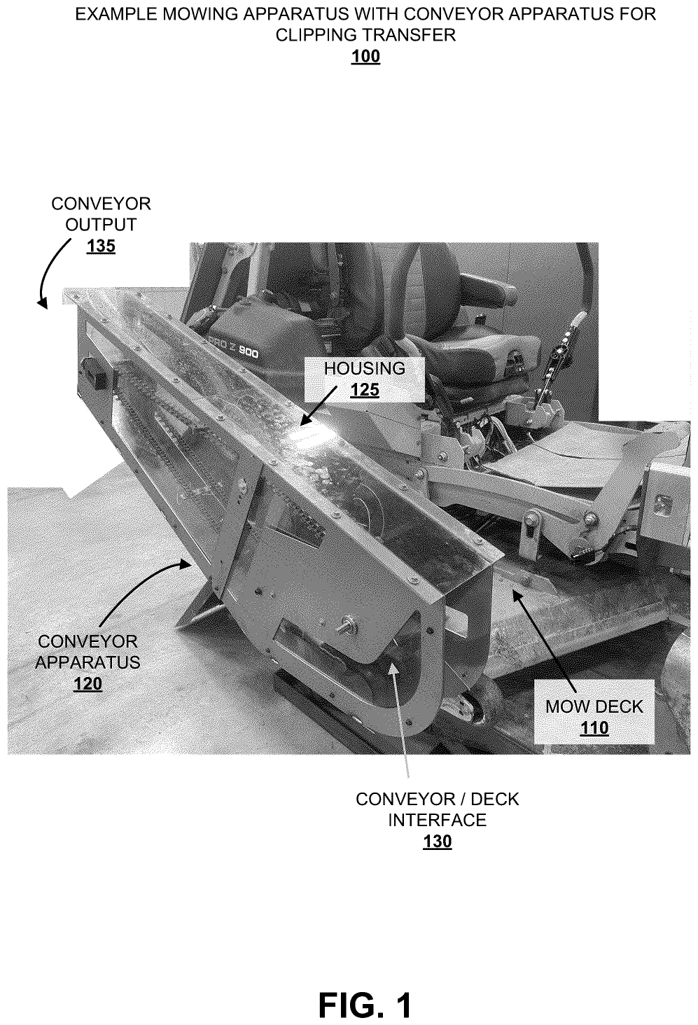

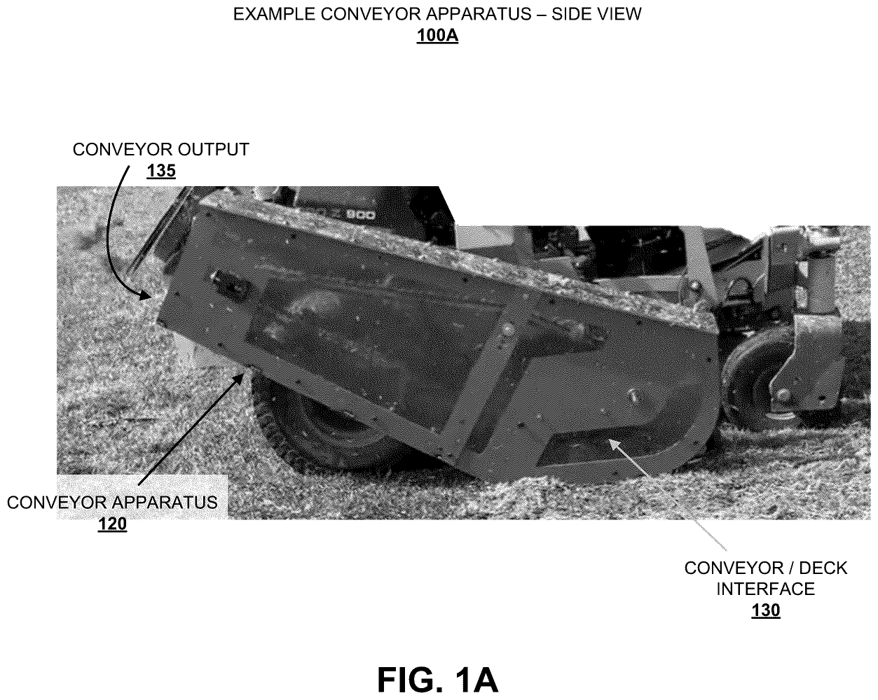

FIG. 1 provides an image of a mowing apparatus 100 with conveyor apparatus 120 for transfer of material (e.g., turf clippings, vegetation, leaves, dirt, etc.) according to various embodiments of the present disclosure. Mowing apparatus 100 can be a ride-on maintenance apparatus in an implementation, but is not limited to this implementation and can be a sulky-equipped apparatus, a walk-behind apparatus, a tow-behind apparatus, and so forth.

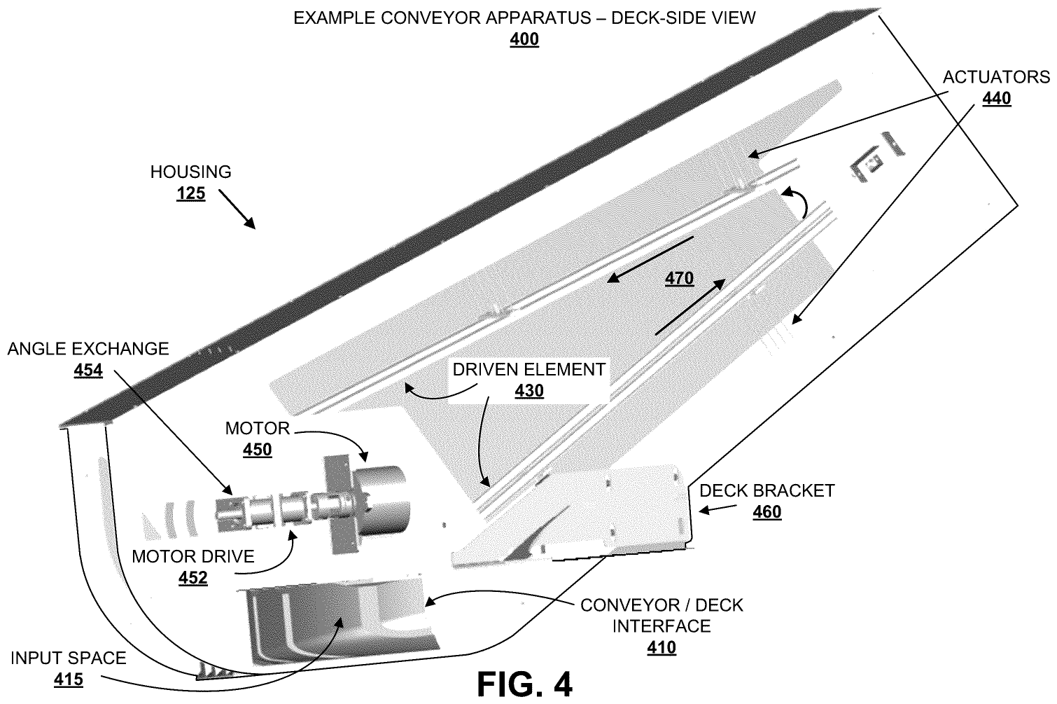

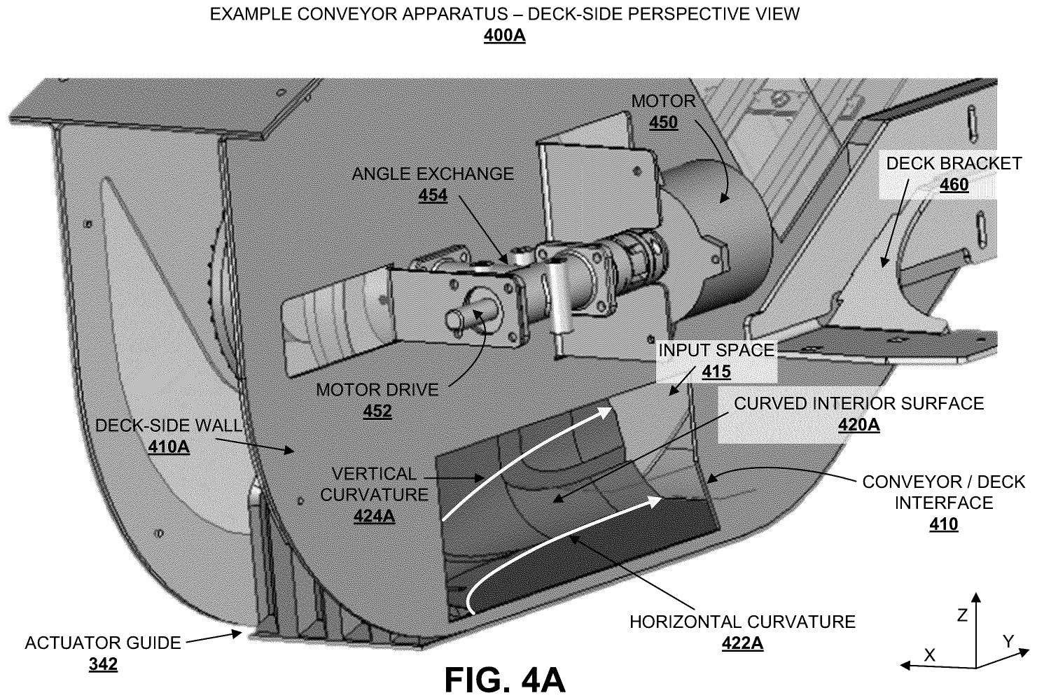

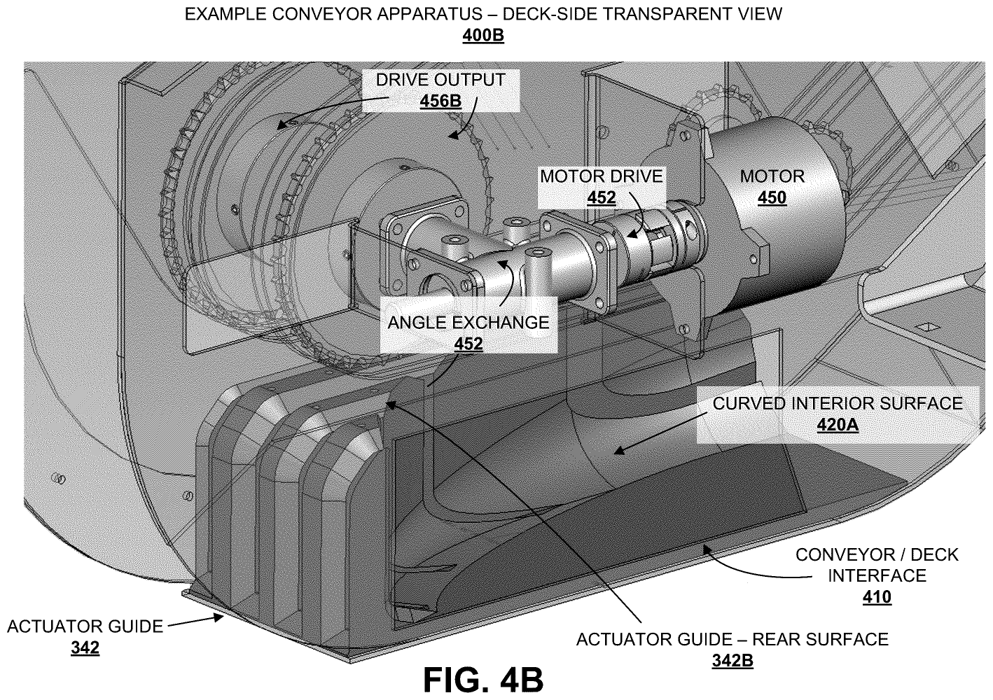

Conveyor apparatus 100 comprises a conveyor/deck interface 130 within a housing 125 (e.g., a shell, a cage, etc.) secured to a mow deck 110 of mowing apparatus 100. Conveyor apparatus 100 can be secured to mowing apparatus 100 at mow deck 110 (e.g., see deck bracket 460 at FIG. 4, infra), secured at a frame of mowing apparatus 100 directly or indirectly (e.g., secured to an element that is itself secured to the frame), or the like, or a suitable combination of the foregoing.

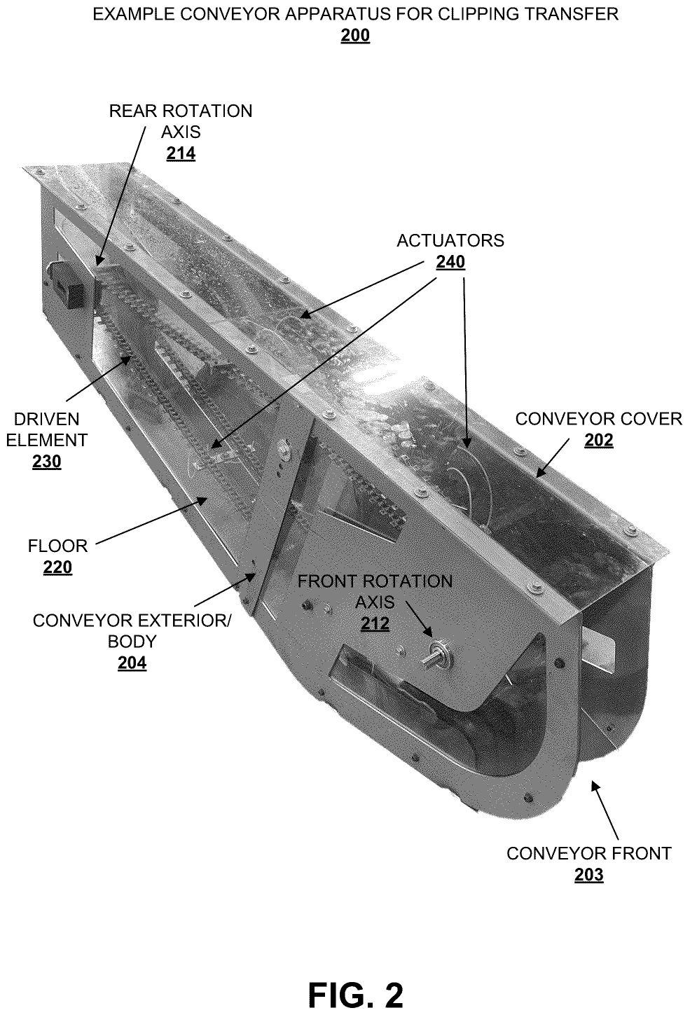

In more detail, conveyor apparatus 120 can be secured to mow deck 110 such that a conveyor/deck interface 130 abuts a discharge port in mow deck 110. Conveyor/deck interface 130 can define an opening in a deck-side surface of conveyor apparatus 120 (e.g., see FIGS. 4, 4A and 4B, infra) in fluid communication with the discharge port in mow deck 110. Accordingly, material such as turf clippings, vegetation (e.g., leaves, plants, or the like, and clippings of the foregoing), dirt and so on driven within mow deck 110 by a cutting unit or other motor drive (not depicted) can enter conveyor/deck interface 130 by way of the opening defined in the deck-side surface thereof. In operation, material entering conveyor apparatus 120 through conveyor/deck interface 130 can move within conveyor apparatus 120 to a conveyor output 135 (if already having sufficient momentum from mow deck 110) or can be moved within conveyor apparatus 120 by a powered implement (e.g., see driven implement 230 of FIG. 2, infra) toward conveyor output 135 as described throughout this specification.

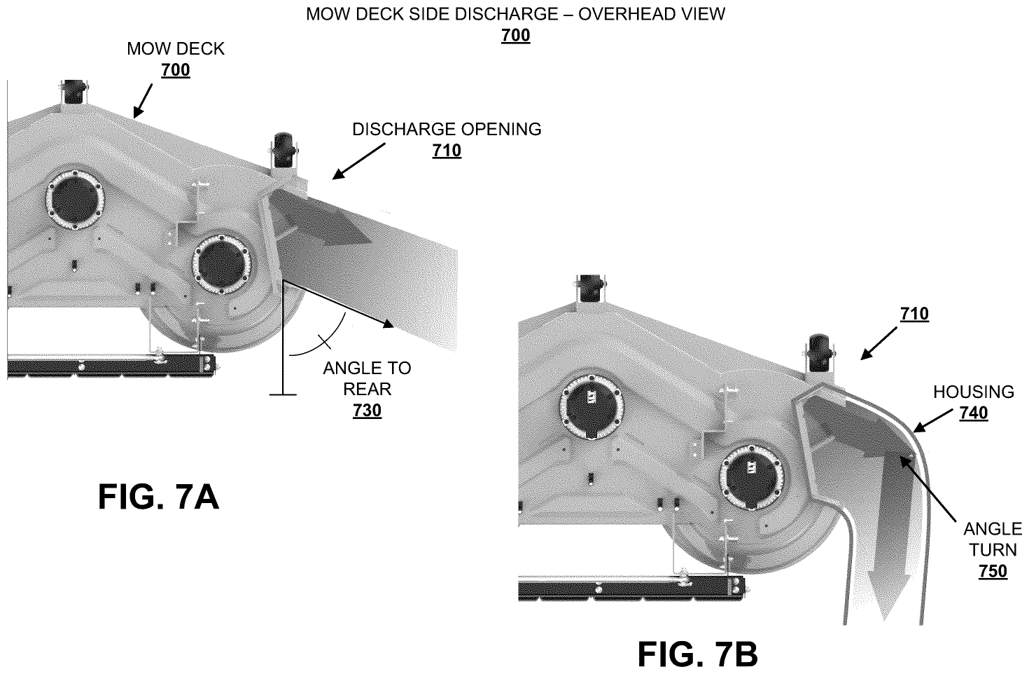

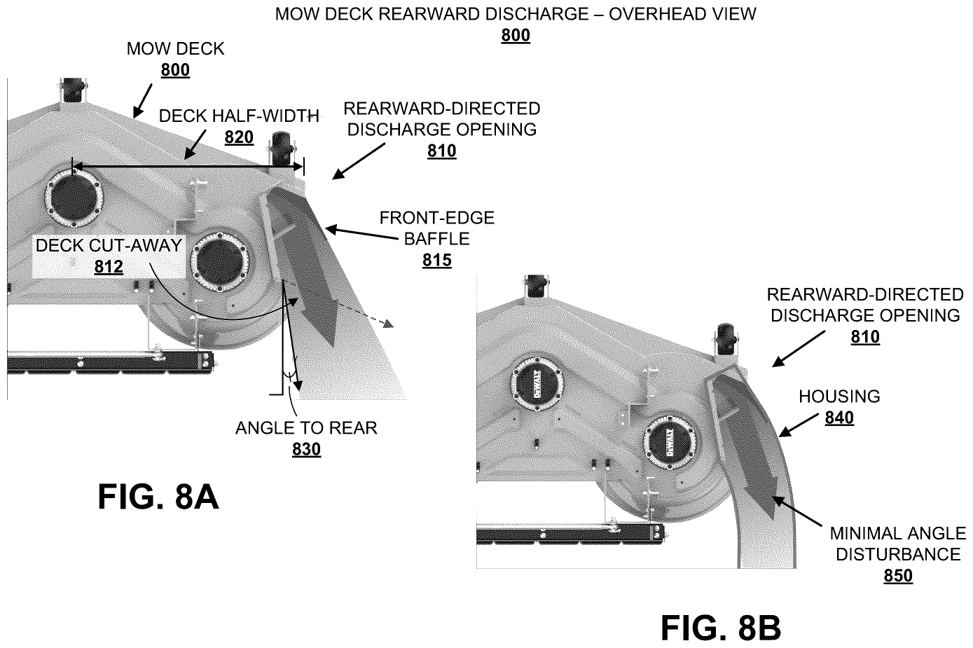

As utilized herein, terms of degree such as approximately, substantially, about, roughly and so forth, are intended to incorporate ranges and variations about a qualified term reasonably encountered by one of ordinary skill in the art in fabricating or compiling the embodiments disclosed herein, where not explicitly specified otherwise. For instance, a term of degree can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, terms of degree can refer to a variation in a disclosed value or characteristic; e.g., a 0 to five-percent variance or a zero to ten-percent variance from precise mathematically defined value or characteristic, or any suitable value or range there between can define a scope for a disclosed term of degree. As an example, a rear discharge angle (e.g., see FIGS. 7A, 7B, 8A and 8B, infra) can define an angle to a fixed direction (e.g., a rear direction; 180 degrees from a forward direction of travel; etc.) with a variance within reasonable manufacturing tolerances, a variance of 0 to five-percent of a disclosed angle(s), a variance of 2-3 degrees or less of the disclosed angle(s), or any suitable value or range there between. These or similar variances can be applicable to other contexts in which a term of degree is utilized herein such as timing of a computer-controlled signal, power applied by a motor onto a component of a disclosed maintenance apparatus, accuracy of measurement of a physical effect (e.g., a dimension, a torque output, an electric power consumption, etc.) or the like.

FIG. 1A illustrates a side view 100A of conveyor apparatus 120 in operation. In the embodiment illustrated by side view 100A, conveyor apparatus 120 is secured to a ride-on mowing apparatus and receives turf clippings (and other material) from a discharge port defined in the mow deck of the ride-on mowing apparatus through a conveyor/deck interface 130. The turf clippings can be ejected from a conveyor output 135 as shown.

FIG. 2 provides an image of a front perspective view of an example conveyor apparatus 200 according to further embodiments of the present disclosure. Conveyor apparatus 200 includes a conveyor exterior 204—which can also be described as a housing, a body, a structure, or the like—having a conveyor top 202 and conveyor front 203 orientated as shown. In addition, a floor 220 is provided to define a structural bottom for conveyor apparatus 200.

An interior of conveyor apparatus 200 includes a driven element 230. Driven element 230 can be powered within the interior of conveyor apparatus 200 to drive material therein (e.g., received near conveyor front 203) to a conveyor output (e.g., see conveyor output 135 at FIGS. 1 and 1A). Driven element 230 can be powered by a motor connected to conveyor apparatus 200, by a belt coupled to a power-takeoff (PTO) of an attached mowing apparatus, by a hydrostatic motor driven by another motor linked to a PTO, etc., or the like, or a suitable combination of the foregoing. In some embodiments, driving (e.g., via motor, PTO, etc.) of a conveyor apparatus as discussed herein can be controlled manually (e.g., via an operator input such as a switch, button, knob, graphical user interface, etc.) or automatically (e.g., configured to start simultaneously with or with a first delay relative to starting operation of a mow deck or configured to stop simultaneously with or with a second delay relative to stopping operation of a mow deck, etc.).

In some aspects of the disclosed embodiments, driven element 230 can be powered to rotate about a front rotation axis 212 and a rear rotation axis 214 within the interior of conveyor apparatus 200. Actuators 240 secured to driven element 230 can be driven about a perimeter of driven element 230 within the interior of conveyor apparatus 200. For instance, actuators 240 can be driven along an underside of conveyor cover 202 and over floor 220, effectively sweeping material containing within conveyor apparatus 200 in a direction of rotation of driven element 230.

In an aspect of the disclosed embodiments, driven element 230 rotates clockwise within conveyor apparatus 200 as shown by the view perspective of FIG. 2. In such embodiments, actuators 240 can propel material received within conveyor apparatus 200 or otherwise resting on floor 220 in the clockwise direction. Turf clippings and other material within conveyor apparatus 200 are moved upward along floor 220 to conveyor output 135 at a top and rear of conveyor apparatus 200 (opposite conveyor front 203) to eject the material from conveyor apparatus 200, as described herein.

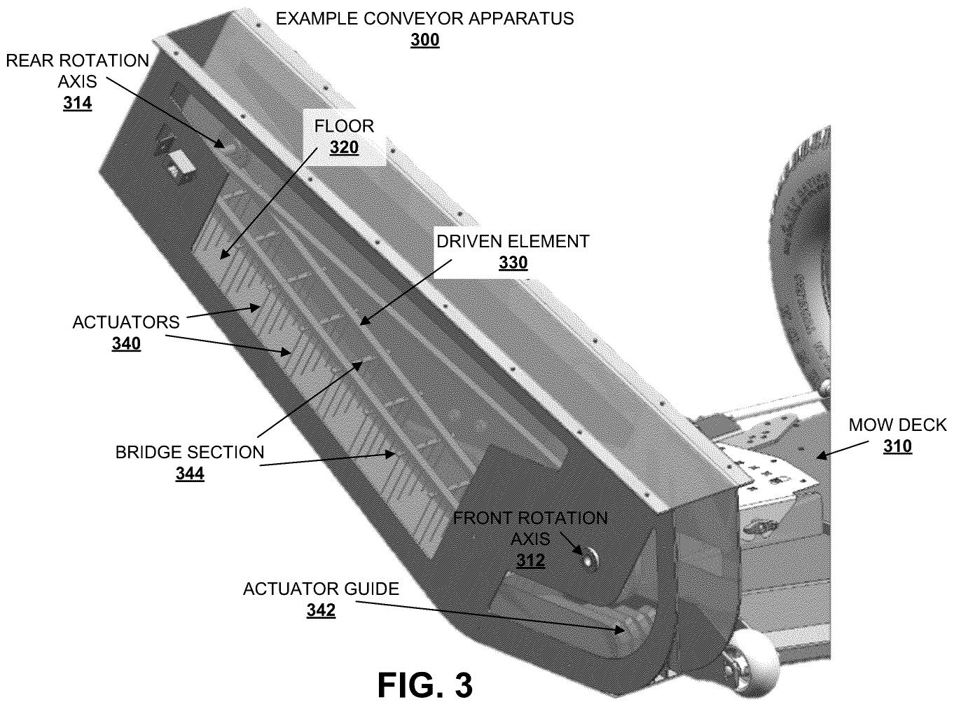

In the embodiment(s) shown in FIG. 2, drive element 230 is embodied by parallel chains mechanically coupled to a sprocket, gearing or other suitable mechanism of front rotation axis 212 and rear rotation axis 214. Actuators 240 can be secured to a bridge section coupled horizontally between the parallel chains (e.g., see bridge section 344 at FIG. 3, infra).

FIG. 3 is a drawing depicting an example conveyor apparatus 300 according to alternative or additional embodiments of the present disclosure. Conveyor apparatus 300 is physically secured to a mow deck 310 of a mowing machine. A driven element 330 within conveyor apparatus 300 can rotate about a front rotation axis 312 and a rear rotation axis 314 thereof. In an embodiment, driven element 330 can comprise one or more chains, belts, straps, ropes, strings, cords, or the like, or a suitable combination of the foregoing. More generally, driven element 330 can be any suitable material or structure having sufficient flexibility to move within conveyor apparatus 300 and sufficient stiffness or tension—at least when driven at suitable speed—to propel material within conveyor apparatus 300 (e.g., via actuators 340, discussed infra). For instance, driven element 330 can propel material along a floor 320 of conveyor apparatus 300 (or, at least in some embodiments, along an interior of a top of conveyor apparatus 300; see, e.g., conveyor cover 202 of FIG. 2, supra).

In an embodiment where driven element 330 comprises a plurality of driven members (e.g., two or more chains, belts, straps, etc., driven in parallel), driven element 330 can also comprise one or more bridge sections 344 connecting the driven members. Actuators 340 can be connected to driven element 330 or to the bridge section(s) 344 (or both) and can extend within conveyor apparatus 300 from driven element 330 to floor 320. Actuators 340 can therefore serve to push material within conveyor apparatus 300 in response to movement of driven element 330.

In some embodiments, actuators 340 can be a rigid or semi-rigid structure extending at least in part between driven element 330 and floor 320 (or between driven element 330 and a conveyor cover 202). In one embodiment(s), an actuator 340 can be a non-rigid structure that can extend outward from driven element 330 in response to motion of driven element 330, e.g., by way of a centrifugal force. The non-rigid structure can cover a first distance from driven element 330 to a surface (e.g., floor 320) when extended and can cover a second distance, shorter than the first distance, from driven element 330 to the surface when not extended. In an alternative embodiment, actuators 340 can be rigid or semi-rigid structures extending a fixed distance or substantially fixed distance at least partway between driven element 330 and the surface.

In further embodiments of the present disclosure, a plurality of actuators 340 can be secured to driven element 330 (e.g., at bridge section 344) and spaced along a direction. The direction can be perpendicular or substantially perpendicular to a direction of motion of driven element 330, in an embodiment(s). An actuator guide 342 can define spaces therein and along the direction. The spaces can define a fixed distance therebetween. Moreover, the plurality of actuators 340 can be restored to the fixed distance between respective actuators 340 when actuators 340 encounter actuator guide 342 in response to motion of drive element 330 and are driven through the spaces defined therein. In some embodiments, actuator guide 342 can be positioned at a front side of conveyor apparatus 300 (e.g., conveyor front 203) near a forward-most portion of the housing. A rear of actuator guide 342 can define a surface curvature to redirect material received within conveyor apparatus 300 along floor 220 toward an output thereof (e.g., see FIG. 4A and FIG. 4B, infra).

The design of actuators can depend on the type of material moved or expected to be moved by the conveyor apparatus. For example, long thin actuators such as those shown in FIG. 3 can efficiently move turf clippings, leaves, etc. Other embodiments can employ additional or alternate actuators, such as more long thin actuators per bridge section; wider actuators (e.g., one or more actuators with a total width of more than a third, more than half, etc. of that of the bridge); wider actuators with holes, mesh, etc. to permit air flow through them; curved or otherwise non-straight (e.g., piecewise linear, etc.) actuators (e.g., actuators curved etc. to impact material with an at least partly concave shape, etc.). In some embodiments, each of the actuators can be identical, while other embodiments can comprise multiple actuators that vary from each other (e.g., a plurality of actuators substantially along each line of one or more lines perpendicular to a direction of motion of the actuators, wherein at least a first actuator of the plurality on a first line is different from at least a second actuator of the plurality on the first line; a first actuator on a first line different from a second actuator on a different second line, such as one or more bridges with actuators configured (e.g., via stiffness, shape, curvature, etc.) to remove more stuck or lodged material from the conveyor apparatus; etc.).

FIG. 4 provides a drawing of a deck-side view 400 of conveyor apparatus 300 according to additional embodiments of the present disclosure. Deck-side view 400 shows a conveyor/deck interface 410 that defines an opening in a deck-side wall (e.g., see FIG. 4A, infra) of a housing 125 of conveyor apparatus 300 and that opens to an input space 415 defined within an interior of conveyor apparatus 300 adjacent the opening of conveyor/deck interface 410.

Actuators 440 coupled to a driven element 430 move through input space 415 in response to rotation of driven element 430. Driven element 430 can move in direction 470 as shown. In response to movement in direction 470 actuators 440 enter input space 415 from a front of conveyor apparatus 300 and move upward therein, pushing material encountered within input space 415 to a top and rear of conveyor apparatus 300.

A motor 450 is provided to generate mechanical power to drive movement of driven element 430 in the embodiments depicted by FIG. 4. In other embodiments, mechanical power can be generated by a motor, engine, prime mover, etc., of a mowing machine to which conveyor apparatus is secured, and a PTO belt, gearing apparatus or other structure can couple to a power output of the mowing machine to deliver the mechanical power to driven element 330. Motor 450 can be an electric motor in various embodiments, but is not limited thereto and can be a combustion motor, a hydraulic drive, a pneumatic drive, a magnetic drive, or the like or a suitable combination of the foregoing.

As shown, motor 450 can be secured to the deck-side wall of housing 125 of conveyor apparatus in some disclosed embodiments. The subject disclosure is not so limited, however, and in other embodiments motor 450 can be on any other suitable surface of housing 125 (e.g., a bottom surface, interior surface, exterior surface, top surface, rear surface, front surface, and so forth). A motor drive is coupled to an output of motor 450 and extends mechanical power generated at an output of motor 450 to an optional angle exchange 454. In other embodiments (not depicted), motor 450 can have an output extending into a width dimension of conveyor apparatus 300, and motor drive 452 can couple directly to a drive member of driven element 430 (e.g., and optional angle exchange 454 can be omitted). In the embodiments shown, angle exchange 454 can comprise one or more gears, pulleys, belts, a linked pair of hydraulic motors, or the like to cause mechanical power generated by motor drive 452 to be diverted parallel to a width dimension of conveyor apparatus 300. A sprocket, gear, pulley or the like (e.g., see exchange element 456B of FIG. 4B, infra) coupled to angle exchange 454 can also be coupled to driven element 430. In this manner, mechanical power generated at motor 450 and conveyed to angle exchange 454 by motor drive 452 is also conveyed to driven element 430 to rotate driven element 430 in direction 470. Additionally, although various embodiments show or discuss a motor (or PTO, mow spindle, etc.) driving a conveyor via a front rotation axis (e.g., axis 312, etc.), other embodiments can comprise a motor, etc. driving a conveyor via a rear rotation axis (e.g., axis 314, etc.).

Also shown is a deck bracket 460. Deck bracket 460 can embody one mechanism for securing conveyor apparatus 300 to a mowing machine. Deck bracket 460 can comprise a mounting surface that seats flush to a mow deck surface of the mowing machine, allowing a fastening means to secure deck bracket 460 and conveyor apparatus 300 to the mow deck of the mowing machine. Deck bracket 460 is provided as one example position of a deck bracket, wherein various embodiments can comprise zero, one, or two or more deck brackets, which can be arranged at the illustrated location or different locations.

FIG. 4A provides a drawing of a close-up view 400A of the deck-side perspective of conveyor apparatus 300. Deck-side wall 410A defines (at least a portion of) a surface of a housing 125 of conveyor apparatus 300 adjacent to a mow deck of a mowing machine to which conveyor apparatus 300 is secured (e.g., mow deck 110 of mowing apparatus 100). A deck bracket 460 secured to deck-side wall 410A of conveyor apparatus 300 can further be secured to a top surface of the mow deck to secure conveyor apparatus 300 (at least in part) to the mowing machine. Additionally, deck bracket 460 can position conveyor apparatus 300 with respect to the mow deck so that an opening within deck-side wall 410A defined by a conveyor/deck interface 410 is in fluid communication with a discharge port in the mow deck. Although a specific shape and position relative to a conveyor is shown for a deck bracket (e.g., bracket 460), in various embodiments, other shapes and positions of deck brackets can be employed similarly.

Material ejected from the mow deck can pass through conveyor/deck interface 410 into an input space 415 within conveyor apparatus 300. A bottom and back wall of input space 415 can define a curved interior surface 420A. Curved interior surface 420A can further define a horizontal curvature 422A and a vertical curvature 424A. Horizontal curvature 422A directs material entering input space 415 in a width dimension of conveyor apparatus 300 (e.g., x-direction of three-dimensional axis in lower right of FIG. 4A) to or toward a length dimension thereof (e.g., y-direction of three-dimensional axis). Similarly, vertical curvature 424A directs material upward within an interior of conveyor apparatus 300 toward an output thereof.

FIG. 4B provides a drawing of a transparent view 400B of a housing 125 of conveyor apparatus 300, according to further embodiments of the present disclosure. More specifically, transparent view 400B depicts deck-side wall 410A of housing 125 as partially transparent. An actuator guide 342 is visible from transparent view 400B. Actuator guide 342 defines one or more spaces therein through which actuators of a driven element can travel as described herein. Actuator guide 342 can define a rear surface 342B. In some embodiments, rear surface 342B can be coincident with curved interior surface 420A, discussed above, including horizontal curvature 422A, or including vertical curvature 424A, or both. The front of actuator guide 342 directs actuators 440 through to the rear surface 342B where material received from the mow deck contacts curved interior surface 420A. The actuators 440 then encounter the material to drive it within conveyor apparatus 300 to an output thereof. The specific shape of an actuator guide can vary based on the shape of the associated actuators, and some embodiments can omit an actuator guide.

Transparent view 400B also shows angle exchange 452 providing a mechanical output within an interior of conveyor apparatus 300. The mechanical output of angle exchange 452 can be connected to a drive output 456B. Drive output 456B can be embodied by one or more gears, sprockets, pulleys, or the like, or a suitable combination of the foregoing. Further, drive output 456B is coupled to a driven element 430 of conveyor apparatus 300 described herein. As noted above, while FIG. 4B and other Figures discussed herein show a motor driving a conveyor apparatus via a front rotational axis, in other embodiments, similar components and techniques can be employed to a drive a conveyor apparatus via a rear rotational axis.

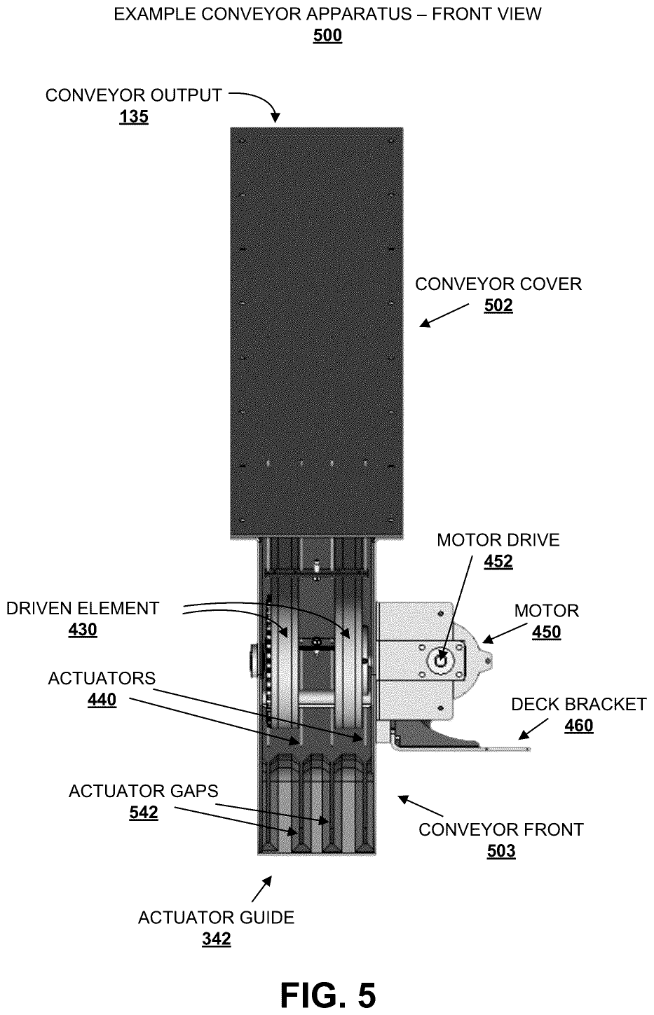

FIG. 5 provides an illustration of a front view 500 of a disclosed conveyor apparatus according to still further embodiments of the present disclosure. The conveyor apparatus comprises a housing that includes a conveyor cover 502 with a conveyor output 135 at a rear thereof (near the top of the front view 500). At a conveyor front 503 of the conveyor apparatus, near a bottom of front view 500, a driven element 430 is visible and is coupled to a drive output of a motor drive 452 and motor 450 secured to the conveyor apparatus. Rotation of the drive output causes movement of driven element 430 within conveyor apparatus, and drives actuators 440 toward an actuator guide 342 at conveyor front 503. Gaps 542 are provided that define spaces within actuator guide 342 through which actuators 440 can travel through actuator guide 342 toward an interior portion of the conveyor apparatus. Each of gaps 542 can have a fixed width there between. Gaps 542 can therefore cause each of actuators 440 to have (or maintain) the fixed width between respective ones of the actuators 440. This helps to ensure a uniform or substantially uniform distribution of actuators 440 across a width of conveyor front 503, which in turn optimizes engagement of material within the conveyor apparatus (e.g., input space 415 of FIG. 4, supra) by actuators 440.

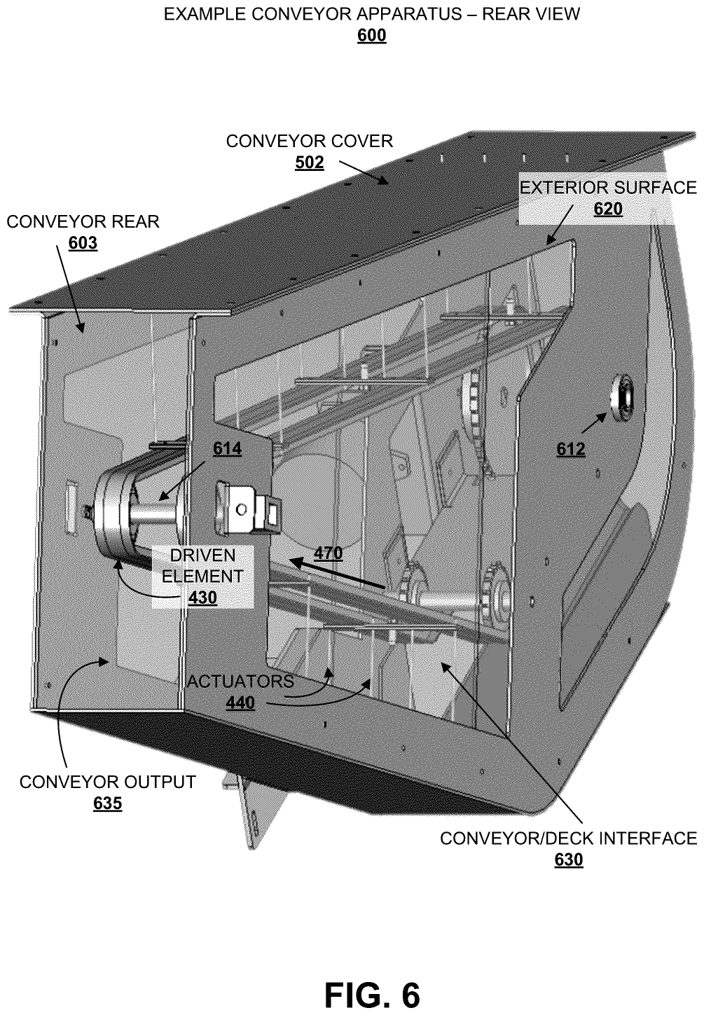

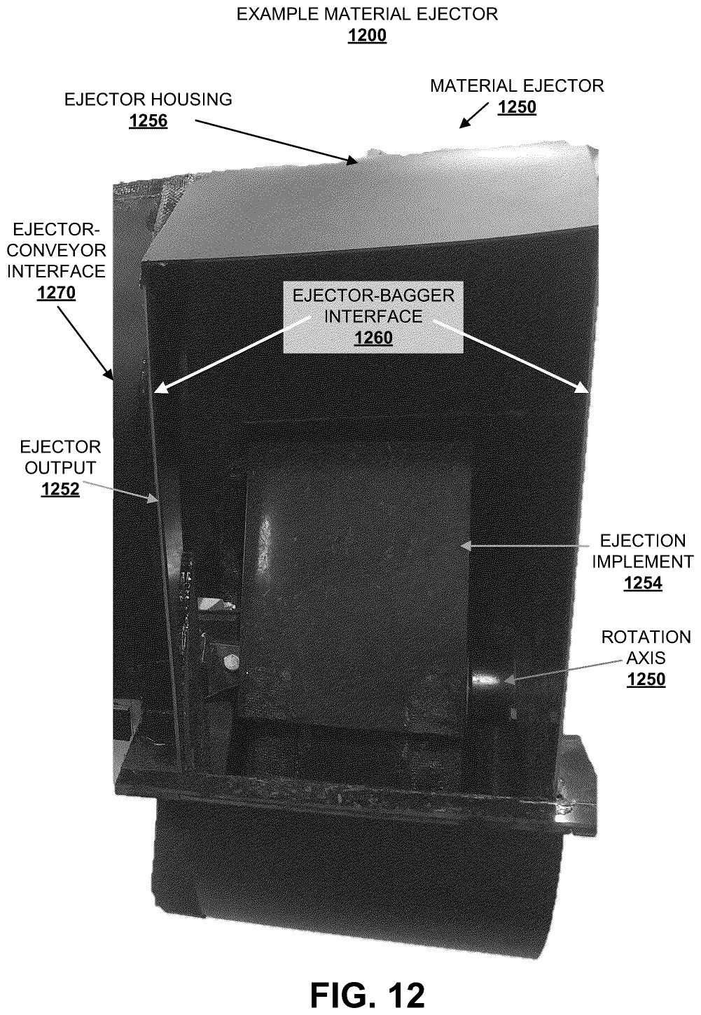

FIG. 6 provides a drawing of a rear view of a conveyor apparatus 600 according to still further embodiments of the present disclosure. A conveyor cover 502 serves as a top housing surface of the conveyor apparatus 600 with a conveyor rear 603 in a foreground portion of the drawing. Conveyor rear 603 defines an opening that serves as a conveyor output 635 for conveyor apparatus 600. Material entering conveyor apparatus 600 is expelled there from by operation of a driven element 430 and actuators 440, as described herein. Likewise, material propelled through conveyor apparatus 600 by airflow generated at an attached mowing machine can also exit conveyor apparatus at conveyor output 635. In some disclosed embodiments, conveyor output 635 can couple to a receptacle, bagging apparatus, or the like (not depicted) for storage of the material during operation of the mowing machine to which conveyor apparatus 600 is attached. In other embodiments, a conveyor output (e.g., conveyor output 635, etc.) can be coupled to a material ejector (see, e.g., FIGS. 12-16, discussed infra) that can actively or passively eject material received from a conveyor (e.g., to a storage system such as a bagging system, to the ground, etc.).

An exterior surface 620 of the housing of conveyor apparatus 600 is shown partially transparent. Exterior surface 620 is opposite a deck-side surface of conveyor apparatus 600 (e.g., see deck-side wall 410A of FIG. 4A, supra). Through the transparent portion of exterior surface 620 a conveyor/deck interface 630 as described herein is visible, providing a relative orientation of the rear view depicted in FIG. 6 compared to front view 500 of FIG. 5, for example.

Also visible through the transparent portion of exterior surface 620 is a driven element 430. Driven element 430 is powered to rotate in a direction 470 driving actuators 440 upward along a floor and bottom surface of conveyor apparatus 600 toward conveyor output 635. Actuators 440 move through conveyor output 635 following rotation of driven element 430 in direction 470 about a rear rotation axis 614 of conveyor apparatus 600 and return to a front of conveyor apparatus along an upper track portion visible through transparent portion of exterior surface 620. As driven element 430 rotates about a front rotation axis 612 of conveyor apparatus 600, actuators 440 are brought into engagement with an actuator guide as described at FIGS. 3 through 4B, supra to engage additional material entering conveyor apparatus 600 through conveyor/deck interface 630. Through continuous operation of driven element 430 different sets of actuators 440 respectively engage portions of such material, driving the material along the floor surface of conveyor apparatus toward and out conveyor output 635.

FIGS. 7A and 7B depict an overhead view of a mow deck 700 according to further embodiments of the present disclosure. Mow deck 700 can be a side discharge mow deck or a top discharge mow deck, or a suitable combination of the foregoing. Mow deck 700 includes a discharge opening from which turf clippings, leaves, vegetation, loose dirt and other material can be expelled during operation of a cutting unit beneath mow deck 700. As is shown at FIG. 7A, discharge opening 710 defines an angle to rear 730 suitable to distribute turf clippings and other material in a relatively uniform distribution out a lateral direction from mow deck 700 through discharge opening 710. In an embodiment, angle to rear 730 can be in a range from about 55 degrees to about 75 degrees from a rearward direction as shown, or any suitable value or range there between.

FIG. 7B illustrates an outline of a housing 740 coupled to discharge opening 710 and configured to capture turf clippings and other material expelled from discharge opening 710 therein. Housing 740 can comprise a disclosed conveyor apparatus in various embodiments, including a conveyor/deck interface immediately adjacent to (and in fluid communication with) discharge opening 710 such that material expelled from discharge opening 710 is received within the conveyor apparatus through the discharge opening, as described herein. As shown in FIGS. 4A and 4B, a curved interior surface 420A can redirect material moving in a direction shown by angle to rear 730 further rearward as shown at angle turn 750. The angle turn 750 can slow down the momentum of the material, potentially causing a backup of material within housing 740 at angle turn 750 in the event of very high volumes of material, high density of material, wet material, or the like entering housing 740.

FIGS. 8A and 8B disclose a drawing of a rearward directed discharge for a mow deck 800 according to still further embodiments of the present disclosure. Referring to FIG. 8A, mow deck 800 has a rearward directed side discharge opening 810. Rearward directed discharge opening 810 has an angle to rear 830 smaller than angle to rear 730 of FIGS. 7A and 7B.

In various embodiments, rearward-directed discharge opening 810 can be implemented with a front-edge baffle 815 that contains turf clippings and material driven within mow deck 800 by a cutting unit along a further arc than discharge opening 710 of mow deck 700, as shown by the shaded arrow within rearward-directed discharge opening 810. Front-edge baffle 815 can maintain contact between the cutting unit (e.g., edge of a blade) and turf clippings and other material until front-edge baffle ends and the material exits rearward-directed discharge opening 810. This causes the material to maintain energy provided by the cutting unit until the material exits the discharge opening. The location of rearward directed side discharge opening 810 in mow deck 800 can be similar (or identical, depending on the embodiment) to that of side discharge opening 710 in mow deck 700, but the use of front-edge baffle 815 or similar redirection surface(s) (e.g., a piecewise approximation of the curve of front-edge baffle 815, etc.) can provide for more efficient movement of material to the rear of a vehicle employing rearward-directed discharge opening 810 (and similarly with embodiments 900 and 1000, discussed infra)

Additionally, rearward-directed discharge opening 810 can optionally be implemented with a deck cut-away 812 that removes a section of mow deck 800 and opens a rearward arc of the mow deck 800. The rearward arc opened by deck cut-away 812 is shown between the gray dotted line and the new rear opening in rearward-directed discharge opening 810 as shown in FIG. 8A. In an embodiment, angle to rear 830 can be less than thirty degrees. In another embodiment, angle to rear 830 can be in a range from about ten to about thirty degrees, or any suitable value or range there between (e.g., 10, 12, 15, 17, 20, 24, 28, 30 degrees, etc., or 10 to 15, 12 to 17, 15 to 20, 20 to 25, 23 to 28 degrees, and so forth).

As shown in FIG. 8B, a housing 840 can be secured to mow deck 800 covering rearward-directed discharge opening 810 and optionally covering front-edge baffle 815. Housing 840 receives turf material output from rearward-directed discharge opening 810 with minimal angle disturbance 850 together with directing the turf material toward a rear of housing 840. This significantly improves retention of momentum of the turf material as it transitions from mow deck 800 into and through housing 840, optimizing energy efficiency associated with transferring turf material into and through housing 840 (e.g., a disclosed conveyor apparatus).

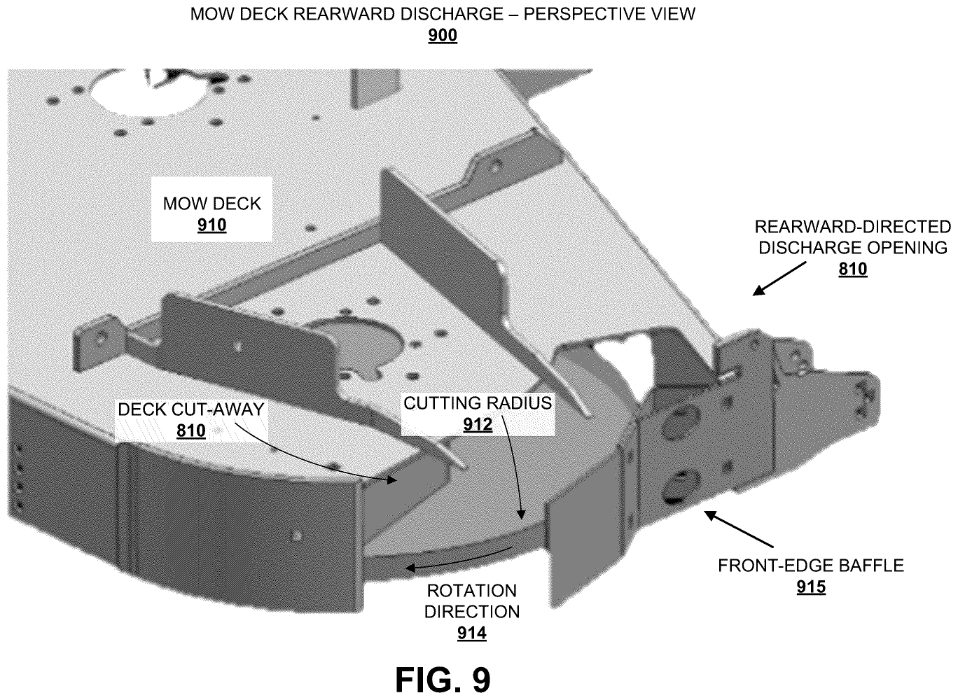

FIG. 9 depicts a perspective view 900 of a mow deck 910 according to further embodiments of the present disclosure. Mow deck 910 defines a rearward-directed discharge opening 810 in mow deck 910. A cutting radius 912 of a cutting unit secured to mow deck 910 provides kinetic energy to loose material within mow deck 910. Front-edge baffle 915 extends an exterior wall around an arc of cutting radius 912 beyond an opening defined in mow deck 910 by rearward-directed discharge opening 810. The loose material maintains the kinetic energy until the extended wall of front-edge baffle 915 is exceeded in rotation direction 914. A deck cut-away portion 810 maintains the opening following the extended exterior wall provided by front-edge baffle 915 up to an angle to rear 830 as shown in FIGS. 8A and 8B, supra.

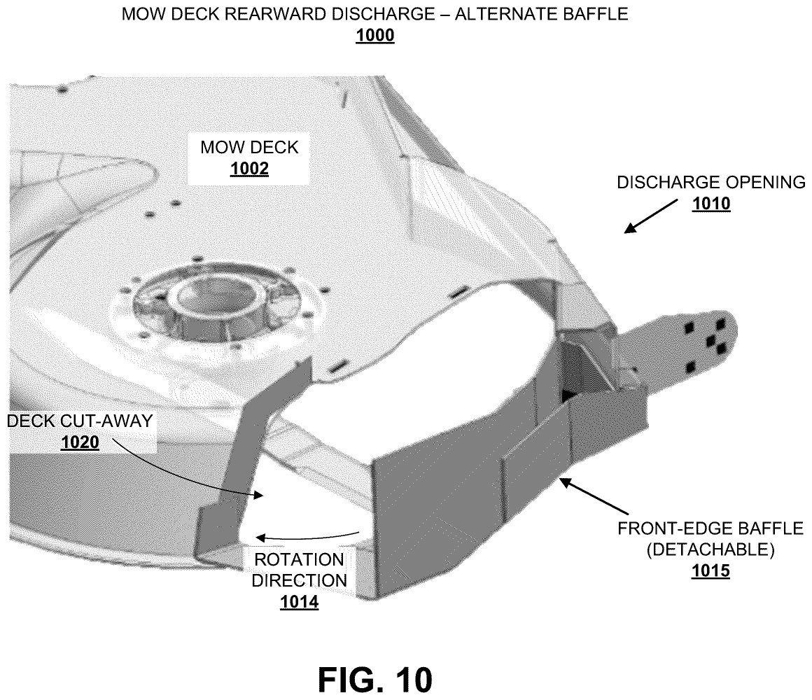

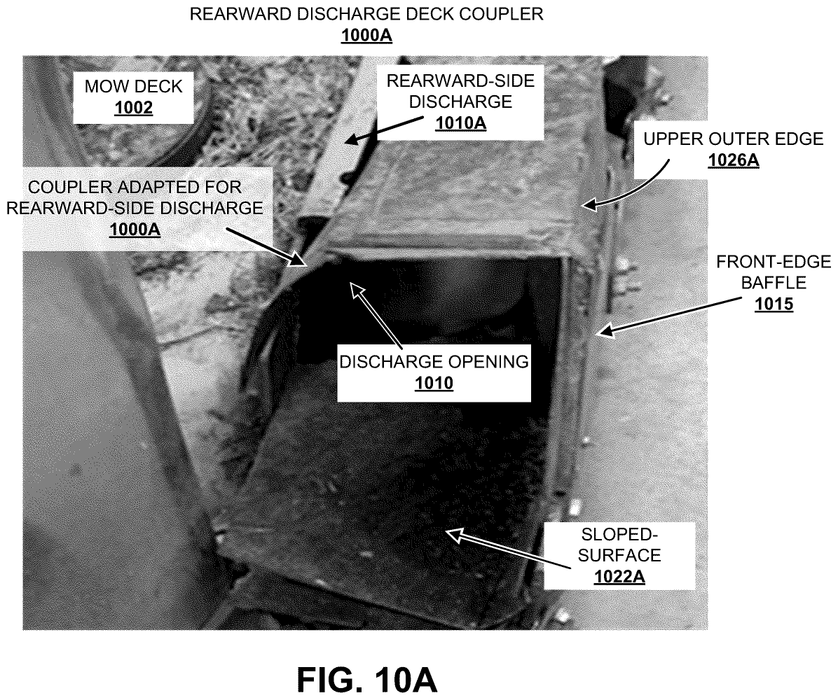

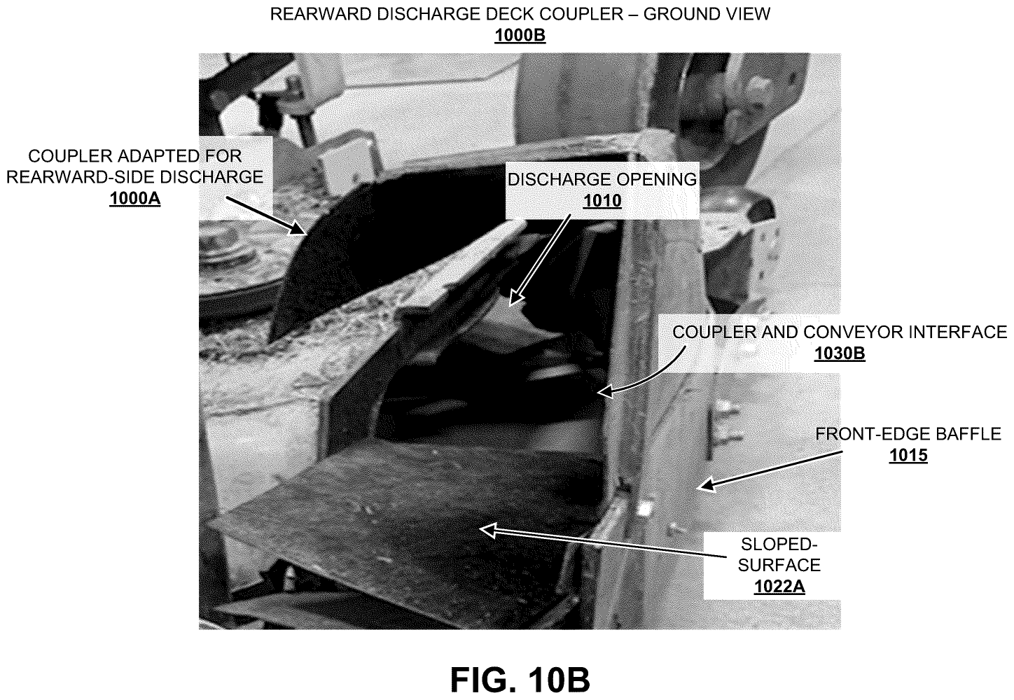

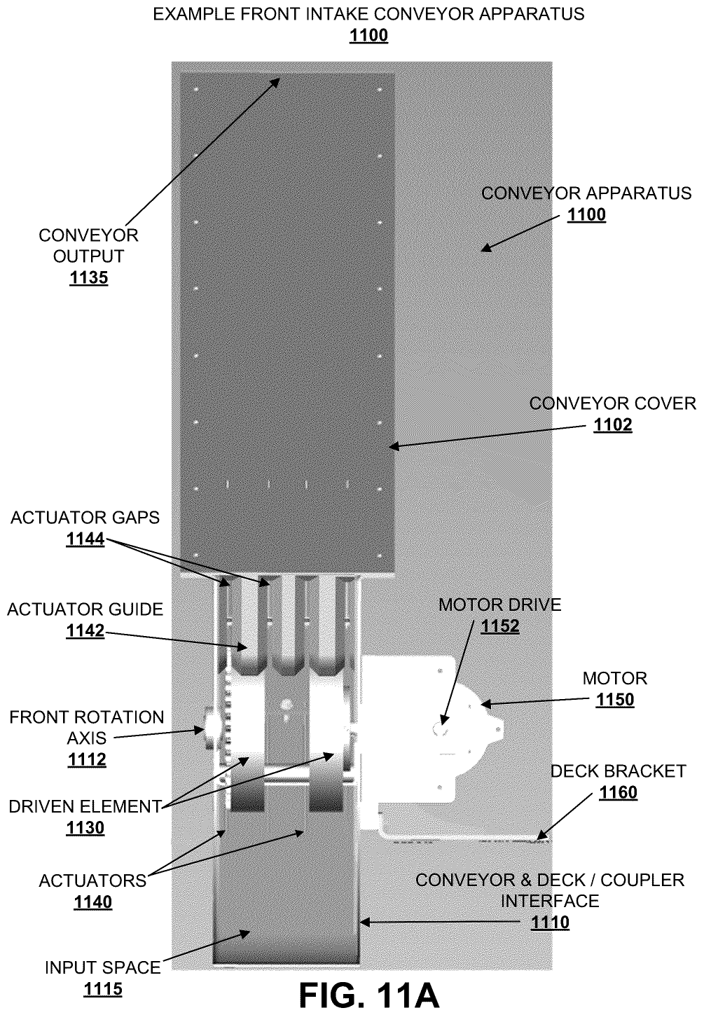

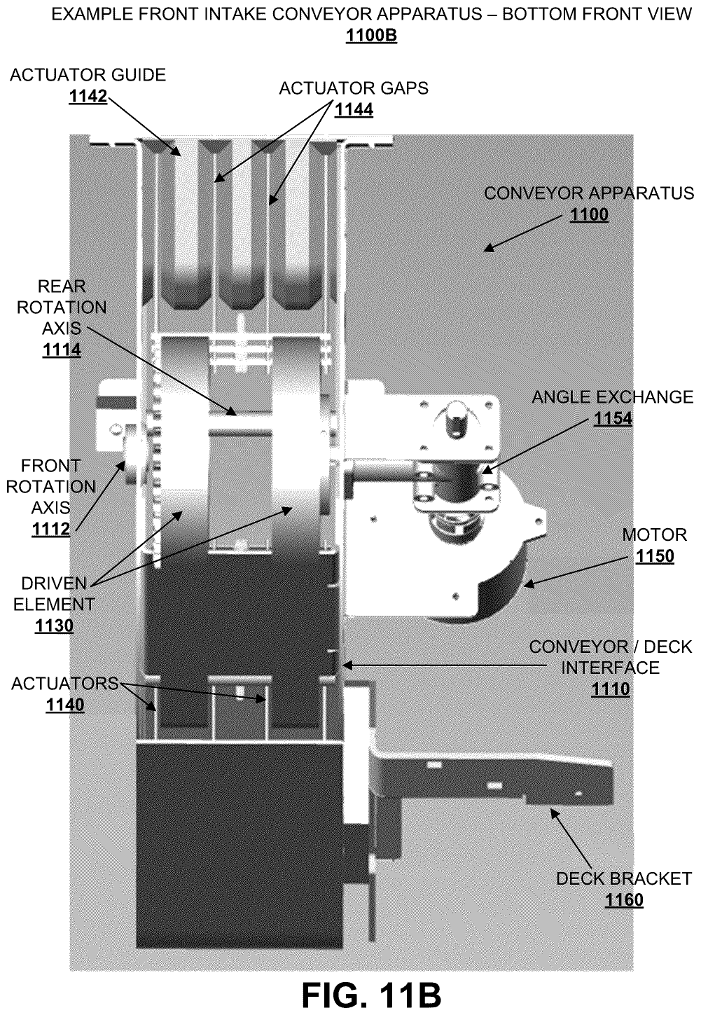

FIG. 10 depicts an alternative baffle 1000 for a rearward discharge mow deck according to still further embodiments of the present disclosure. Mow deck 1002 defines a discharge opening 1010, including a deck cut-away 1020 opening the discharge opening 1010 to an angle to rear similar to angle to rear 830 as shown in FIGS. 8A and 8B. A front-edge baffle 1015 is shown that is removably attachable to mow deck 1002 to extend an arc of a perimeter of mow deck 1002 through discharge opening 1010 in rotation direction 1014 toward the deck cut-away portion 1020. Front-edge baffle 1015 can be attached to mow deck 1002 as shown to implement rearward-directed discharge into a housing, such as a disclosed conveyor apparatus (e.g., front intake conveyor apparatus 1100A of FIG. 11, infra, among others), to implement a bagging mode for mow deck 1002.

For a side-discharge mode, front-edge baffle 1015 can be removed and a side-discharge chute can be inserted into discharge opening 1010. In one or more embodiments, side-discharge chute can have a deck cut-away material attached, formed, molded or otherwise integral to the side-discharge chute. The deck cut-away material can restore a portion of a rear of mow deck 1002 removed as shown in FIG. 8A (dashed arrow) compared with FIG. 7A. Stated differently, the deck cut-away material can restore the mow deck discharge opening to have angle to rear 730 as shown in FIG. 8A, to implement the side-discharge mode.

As shown in FIGS. 3-4B, various embodiments of a conveyor apparatus can provide for a side intake of material, such as turf clippings from a mow deck of a turf maintenance apparatus, etc. In other embodiments, however, a conveyor apparatus can be employed that provides for front intake of material (e.g., such as turf clippings from a mow deck of a turf maintenance apparatus, etc.). Some embodiments can combine or employ a front-intake conveyor apparatus in connection with a rearward discharge from a mow deck (e.g., see FIGS. 8A-10). Referring to FIGS. 11A and 11B, illustrated are a front image 1100A and a bottom front image 1100B of an example front intake conveyor apparatus 1100, according to various aspects discussed herein. Moreover, FIGS. 10A and 10B depict an example coupler apparatus 1000A that mechanically interfaces an output of the mow deck 1002 with the front intake of conveyor apparatus 1100.

In side-intake embodiments (e.g., as shown in FIGS. 1-6), material enters an input space of a conveyor apparatus from an outdoor power equipment (e.g., from a mow deck) via a conveyor/deck interface on the side of the conveyor apparatus (e.g., see input space 415 on a side of housing 125 as shown in FIG. 4, supra). Because of the side input of material, material is redirected (e.g., via curved interior surface 420A, etc.) to travel along the conveyor apparatus, based on its own momentum or by being pushed by actuator(s) of the conveyor apparatus.

FIG. 10A depicts a rearward discharge deck coupler 1000A in further aspects of the disclosed embodiments. Particularly, coupler 1000A can be adapted to sit within a discharge opening 1010 of mow deck 1002 with an intake of coupler 1000A adjacent to a rearward-side discharge 1010A of mow deck 1002. Coupler 1000A includes a sloped surface 1022A that guides material ejected from discharge opening 1010 away from mow deck 1002 toward an intake of conveyor apparatus seated at the opening of coupler 1000A, shown in FIG. 10A. Coupler 1000A can be positioned within and secured to front-edge baffle 1015. Surfaces of coupler 1000A confine the material to the opening defined in coupler 1000A, however, because the rearward side discharge 1010A facilitates minimal angle disturbance 850 of the material (see FIG. 8B, supra) as the material exits mow deck 1002, the surfaces of coupler 1000A are expected to have little impact on the speed and momentum of the material as it moves within coupler 1000A to the output thereof.

In one or more aspects of the disclosed embodiments, a top surface of coupler 1000A can be flat or substantially flat, and an upper outer edge 1026A of coupler 1000A can have approximately a square edge (e.g., forming a ninety degree or substantially ninety degree angle) as shown in FIG. 10A. This geometry of the top surface and of upper outer edge 1026A can facilitate a fluid dynamic that retains fluid at or near the top surface of coupler 1000A. Thus, air moving near the top surface of coupler 1000A (and material blown by the air) can be retained at or near the top surface of coupler by the flatness of the top surface and the approximately square edge of upper outer edge 1026A.

FIG. 10B shows a ground view 1000B of coupler 1000A positioned adjacent discharge opening 1010 of mow deck 1002 in further aspects of the disclosed embodiments. Coupler 1000A can be secured within front-edge baffle 1015 so that an intake of coupler 1000A is in fluid communication with discharge opening 1010, as shown. An output of coupler 1000A can define a coupler and conveyor interface 1030B to be positioned in fluid communication with a front intake of a front intake conveyor apparatus (e.g., see FIGS. 11A and 11B, infra). Sloped surface 1022A can direct material ejected from discharge opening 1010 along a bottom surface of coupler 1000A to the front intake of the conveyor apparatus.

FIGS. 11A and 11B show a front intake conveyor apparatus 1100 that defines a conveyor and deck/coupler interface 1110 that can be positioned in fluid communication with coupler and conveyor interface 1030B of coupler 1000A as shown in FIG. 10B, supra. As shown, in a front-intake embodiment such as conveyor apparatus 1100, material enters an input space 1115 by being discharged from the outdoor power equipment (e.g., from a mow deck of a turf maintenance apparatus) through a conveyor/deck interface 1110 with a momentum substantially aligned with a long axis of the conveyor apparatus 1100. Conveyor apparatus 1100 comprises one or more driven elements 1130 that can be driven by mechanical power (e.g., from a PTO, etc.) or an electrical motor such as motor 1150, which can drive one of a front rotation axis 1112 or a rear rotation axis 1114 (FIG. 11B) directly via a motor shaft such as motor drive 1152, via an angle exchange 1154 (FIG. 11B), etc. Material can be moved up a bottom surface of the conveyor apparatus 1100 by its momentum or actuator(s) 1140 to conveyor output 1135 (e.g., for discharge to a storage/bagging system, a material ejector, the ground, etc.). Actuator(s) 1140 can be aligned by actuator gaps 1144 of an actuator guide 1142 at any point after moving material to conveyor output 1135 and before engaging with additional material received via the input space 1115 (e.g., above or substantially above at least a portion of the driven element(s) 1130, etc.). In FIGS. 11A-11B, the actuator guide is located proximate to and above input space 1115, aligning actuators 1140 shortly before engaging with material received into the input space 1115. Because of the location of the input space 1115, the placement of actuator guide 1142 differs from that shown for side intake embodiments but can be placed near a front end of the conveyor apparatus 1100 above intake space 1115, to minimize the time between alignment of actuators 1140 by actuator guide 1142 and engagement of actuators 1140 with material, without obstructing material entering the intake space 1115. One or more deck brackets 1160 can also be included to secure conveyor apparatus 1100 to the outdoor power equipment or provide structural support to conveyor apparatus 1100.

In various embodiments, side-intake or front-intake conveyor apparatuses can be employed in connection with top discharge, side discharge, rearward-directed side discharge, or rear discharge mow decks. For outdoor power equipment with a rear mounted storage or collection system (e.g., bagging system), material can be readily transported to the storage/collection system through a variety of embodiments, such as a side discharge mow deck coupled with a side-intake conveyor apparatus, a rearward-directed side discharge mow deck coupled with a front-intake conveyor apparatus, etc.

Referring to FIG. 12, illustrated is an example side view 1200 of an example material ejector 1250 according to alternative or additional embodiments of the present disclosure. View 1200 shows a material ejector 1250 configured to couple to a conveyor apparatus (e.g., conveyor apparatus 120, etc.). In some embodiments, material ejector 1250 is configured to receive turf clippings and vegetation material from a conveyor apparatus. An ejection implement 1254 secured to a rotation axis 1227 (e.g., which can be substantially perpendicular to the front and rear rotation axes of the conveyor apparatus, etc.) can expel the material (e.g., turf clippings and vegetation material, etc.) from an ejection-bagger interface 1260 out from material ejector 1250. An ejector housing 1256 limits a direction into which the turf clippings and vegetation are expelled to an opening defined by ejector-bagger interface 1260. Where a receptacle, clipping bag or the like secured to the turf maintenance apparatus has an input coupled to ejector-bagger interface 1260, the turf clippings can be expelled into the receptacle or clipping bag. While ejector-bagger interface 1260 in FIG. 12 is shown with a substantially rectangular shape of a specific size, in various embodiments, other shapes (e.g., square, rounded, etc.) of various sizes can alternatively be employed for ejector-bagger interfaces in connection with clipping ejectors discussed herein.

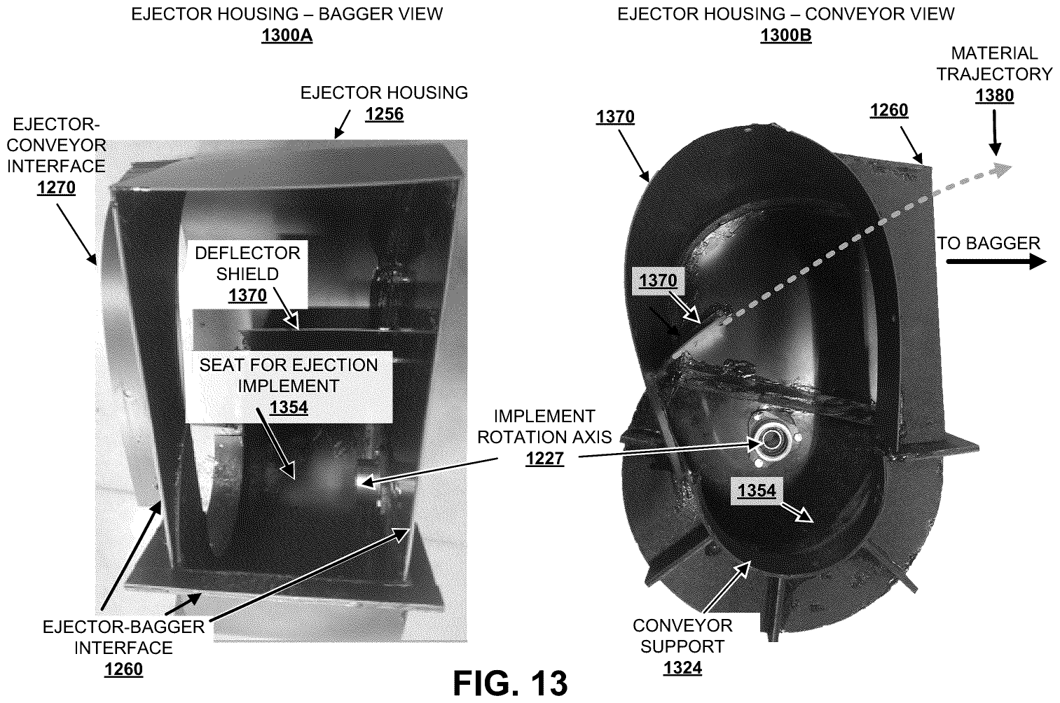

FIG. 13 shows images 1300A and 1300B of ejector housing 1256 separate from a conveyor apparatus and a turf maintenance apparatus to highlight additional aspects of the disclosed embodiments. Image 1300A shows a bagger view 1300A from within a bagger looking into ejector-bagger interface 1260, while image 1300B shows a conveyor view from within a conveyor housing (e.g., housing 125 of FIG. 1) into an ejector-conveyor interface 1270 of ejector housing 1256.

Ejector-conveyor interface 1270 connects to a conveyor output (e.g., 135, 1135, etc.) and material (e.g., turf clippings, etc.) is provided to ejector housing 1256 through ejector-conveyor interface 1270. An ejection implement (not depicted in FIG. 13) is secured to a rotation axis 1227 substantially perpendicular to the front and rear rotational axes of a conveyor apparatus, and rotates within a seat for ejection implement 1354. Ejector-bagger interface 1260 defines an opening into which the ejection implement expels material (e.g., turf clippings, etc.) received from the conveyor apparatus. A deflector shield 1370 over seat for ejection implement 1354 can help define a clipping trajectory 1380 to further define the direction into which the ejection implement expels material from ejector housing 1256.

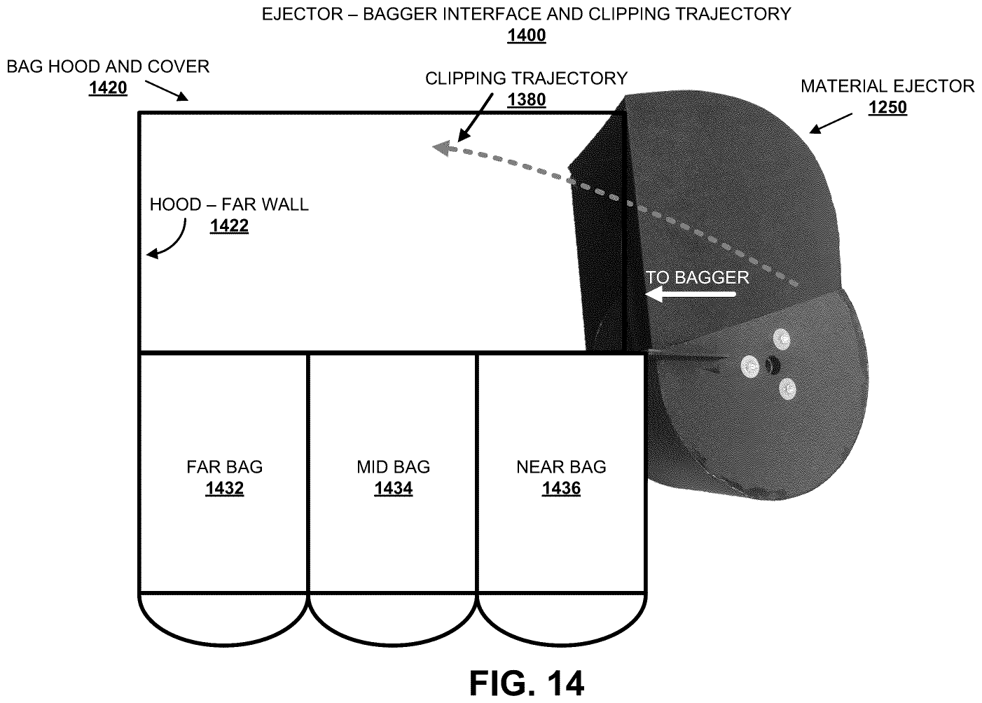

FIG. 14 provides a drawing of an ejector-bagger interface 1400 and clipping trajectory from material ejector 1250 according to various aspects of the disclosed embodiments. As shown, a bag hood and cover is coupled to material ejector 1250 at an ejector-bagger interface 1260. Clipping (or other material, etc.) trajectory 1380 can be established in part by an opening defined by ejector-bagger interface 1260 and by a deflector shield 1370. Clipping trajectory 1380 can direct turf clippings upward out through ejector-bagger interface 1260 toward a far wall 1422 of bag hood and cover 1420. Turf clippings can fill a far bag 1432 first, followed by a mid bag 1434 and finally a near bag 1436 to facilitate complete utilization and filling of a clipping bag or receptacle. In various embodiments, material ejected substantially simultaneously from material ejector 1250 can comprise some material that will end up in far bag 1432, some material that ends up in mid bag 1434, or some material that ends up in near bag 1436, for example, depending on the characteristics of clipping ejector 1250. Clipping ejector 1250 can be designed such that far bag 1432 will fill at an equal or faster rate than mid bag 1434, which will fill at an equal or faster rate than near bag 1436, ensuring that there is no unused space in far bag 1432 or mid bag 1434 which could otherwise result if mid bag 1434 or near bag 1436 filled up first and blocked additional material from entering far bag 1432 or mid bag 1434. However, even if mid bag 1434 fills faster than far bag 1432 or near bag 1436 fills faster than mid bag 1434 or far bag 1432, unused space can still be substantially reduced if they fill at close to the same rate.

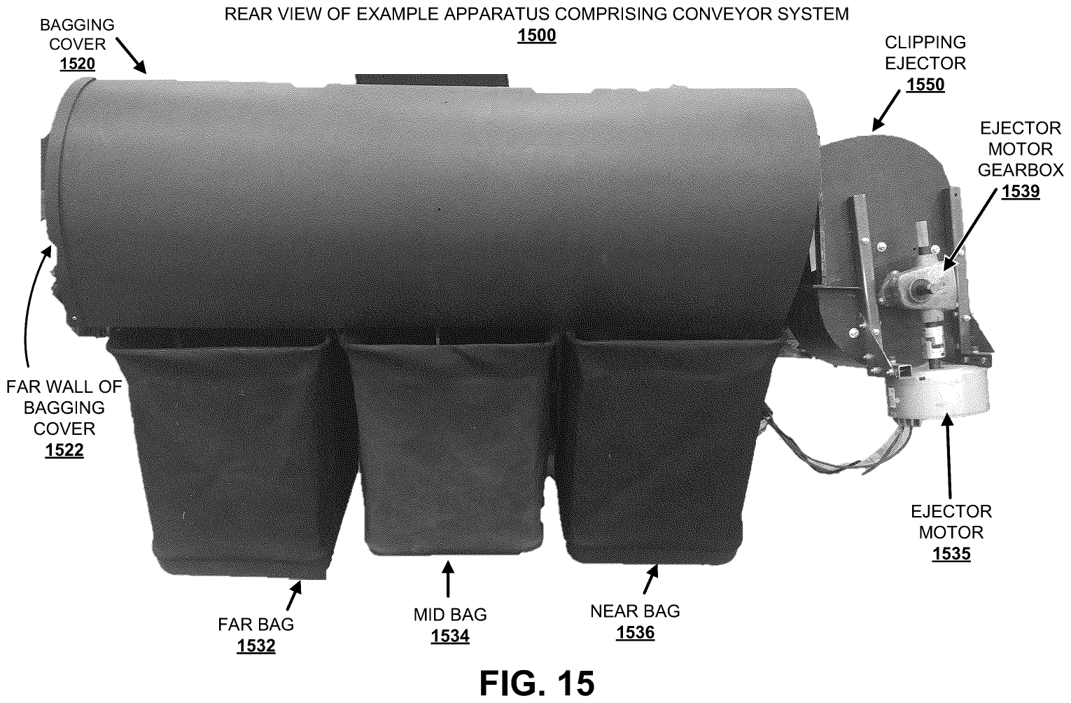

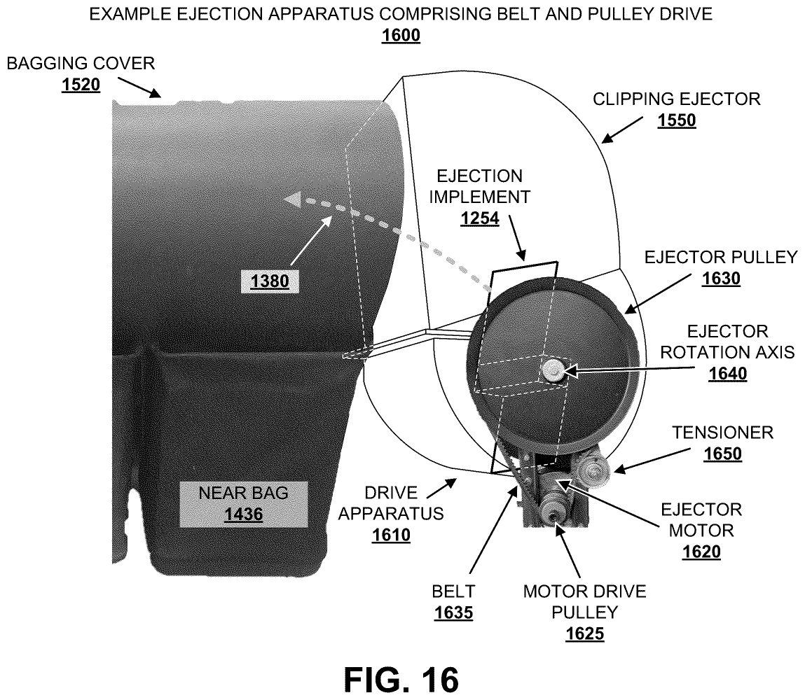

Referring to FIG. 15, shown is a rear view 1500 of an example mowing apparatus that can comprise a conveyor apparatus and bagging system, according to various aspects discussed herein. In the embodiment shown, ejector motor 2635, located proximate to a clipping ejector 1550 and bagging system, can drive ejection implements (not shown, but see ejection implement 1254 of FIG. 16, infra) of clipping ejector 1550. In some embodiments, the same motor (or connection to mechanical power of the outdoor power equipment, such as via the PTO) can be used to drive the conveyor apparatus and material ejector, while in other embodiments, different motor(s) or connection(s) to mechanical power can be used to drive the conveyor apparatus and material ejector. In the embodiment shown, the shaft of ejector motor 1535 is substantially perpendicular to the rotation axis of the ejector implement (not shown, but see ejector rotation axis 1640 of FIG. 16, infra) of clipping ejector 1550, which ejector motor 1535 drives at a reduced speed via ejector motor gearbox 1539 (a 10:1 reduction via worm gears in the embodiment shown, but other embodiments can employ greater or lesser gear reductions or other gearing such as bevel, hypoid, etc.). Although not shown, in other embodiments, the shaft of ejector motor 1535 can be at substantially any angle relative to that of the rotation axis of the ejector implement in clipping ejector 1550, including parallel or coaxial (e.g., and driven via a planetary gearset). Material can be directed from clipping ejector 1550 through an open area under bagging cover 1520 and above far bag 1532, mid bag 1534, and near bag 1536. The angle of ejection from clipping ejector 1550 and the height or top profile of bagging cover 1520 can provide for substantially parabolic motion of material through at least a portion of its motion under bagging cover 1520.

In general, ejected material need not follow a single trajectory 1380 but individual pieces or portions of material will have a trajectory within a range of trajectories. Some portion of material may strike the far wall 1522 of bagging cover 1520 and fall into far bag 1532. Some material can have an unimpeded trajectory that ends in one of far bag 1532, mid bag 1534, or near bag 1536. Even distribution of material landing unimpeded in far bag 1532, mid bag 1534, and near bag 1536 can provide efficient usage of both bagging space and energy. If the material is not evenly distributed, relatively more material landing in far bag 1532 than mid bag 1534 and relatively more material landing in mid bag 1534 than near bag 1536 can also provide efficient usage of bagging space (while still relatively energy efficient), as material that would otherwise land in far bag 1532 will end up in mid bag 1534 when far bag 1532 is full, and material that would otherwise land in mid bag 1534 will end up in near bag 1536 when mid bag 1534 is full (filling mid bag 1534 before far bag 1532 or filling near bag 1536 before mid bag 1534 or far bag 1532 can occur in some embodiments, but will result in less efficient usage of bagging space).

In some embodiments, one or more baffles or redirection surfaces can be employed, such as an optional material baffle within a hood of a bagging system, to ensure optimal or near optimal distribution of material between far bag 1532, mid bag 1534, and near bag 1536. In other embodiments, the range of trajectories from clipping ejector 1550 can be selected or adjustable (e.g., through rotation of clipping ejector 1550, the angle of one or more deflector shields, etc.) to ensure optimal or near optimal distribution of material between far bag 1532, mid bag 1534, and near bag 1536.

FIG. 16 depicts an alternative aspect of the present disclosure with an example ejection apparatus 1600 comprising a drive apparatus 1610. The ejection apparatus 1600 can include clipping ejector 1550, shown as a line drawing in FIG. 16, having an output in fluid communication with a bagging cover 1520 of a bagging apparatus as shown. An ejection implement 1254 is positioned for movement (e.g., rotation, or other movement) within an interior of clipping ejector 1550 to facilitate expulsion of material from clipping ejector 1550 to the bagging apparatus. In the aspects illustrated in FIG. 16, ejection implement 1254 rotates to expel material substantially along trajectory 1380, or a range of trajectories underneath bagging cover 1520. Rotation of ejection implement can be driven by drive apparatus 1610. Drive apparatus 1610 can include an ejection motor 1620 having a motor drive that terminates in a motor drive pulley 1625. Motor drive pulley 1625 is coupled to a belt 1635 that transfers mechanical power from motor drive pulley 1625 to an ejector pulley 1630 that rotates about an ejector rotation axis 1640. Ejection implement 1254 can be secured to ejector rotation axis 1640, such that rotation of ejector pulley 1630 and ejector rotation axis 1640 causes the movement of ejection implement 1254 to cause the expulsion of material from clipping ejector 1550, described above. In one or more aspects of the disclosed embodiments, drive apparatus 1610 can comprise a tensioner 1650 that provides a tension on belt 1635 to facilitate the transfer of mechanical power from motor drive pulley 1625 to belt 1635, and from belt 1635 to ejector pulley 1630.

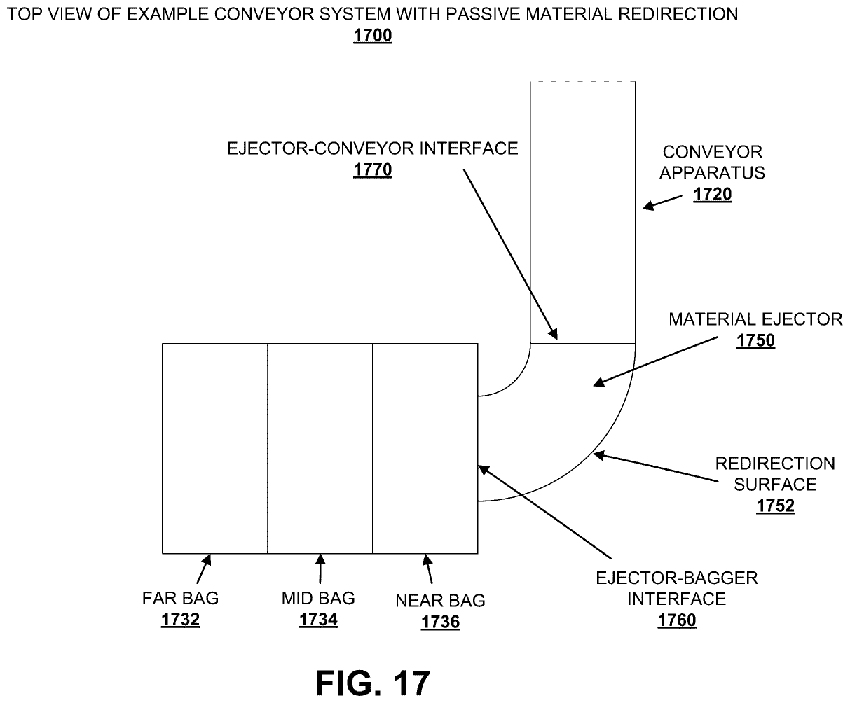

Referring to FIG. 17, illustrated is a top view 1700 of an example conveyor system comprising a material ejector 1750 employing passive material redirection, according to various aspects discussed herein. Material moving through a conveyor apparatus 1720 to a conveyor output can be transferred to a material ejector 1750 via an ejector-conveyor interface 1770. In prototype embodiments wherein the material was turf clippings, the material was moved at a speed of around 30-80 feet per second, although greater or lesser speeds can be employed in various embodiments. The material can be deflected by one or more redirection surfaces 1752 within material ejector 1750 to be ejected out ejector-bagger interface 1760 in a direction substantially perpendicular to a direction of motion of the material when entering material ejector 1750 via interface 1770. Although not shown in FIG. 17, material ejector 1750 can comprise an additional redirection surface to deflect material to have an upward arc similar to trajectory 1380, to facilitate distribution of material between far bag 1732, mid bag 1734, and near bag 1736.

While powered material ejectors are discussed in connection with FIGS. 12-16 and passive material ejectors in connection with FIG. 17, in general, powered or passive techniques and components can be employed in connection with material ejectors of various embodiments. Additionally, while material ejectors discussed herein are shown with an ejector-bagger interface in a substantially vertical plane, in various embodiments, the ejector-bagger interface can be at non-zero angles to a vertical axis, such as opening straight downward (e.g., wherein the ejector-bagger interface is a plane perpendicular to the vertical axis, etc.), opening at any downward angle relative to the vertical axis, or opening at any upward angle relative to the vertical axis. The combination of internal redirection surface(s) (e.g., including a shape of an ejector housing, such as a top profile of the ejector housing, etc.), ejection implement(s), or orientation of the material ejector or ejector-conveyor interface can be employed to select material trajectories, such as for efficient collection and storage of material.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein. As an example, an arrangement of components depicted in one embodiment can be swapped with components depicted in another embodiment, optionally excluding some components or including other components illustrated in a third embodiment, according to design creativity of one of ordinary skill in the art. As a further example, components of disclosed devices can be implemented as connected to other components rather than included within the parent device. For instance, curved interior surface 420A can be separate from actuator guide 342 and the latter can have a rear surface connected to curved interior surface 420A rather than integral thereto. Alternatively, the opposite orientation can be implemented within the scope of the disclosure: one component (e.g., motor 450) depicted separate from another component (e.g., drive output 456B) can be aggregated as a single component in some embodiments (e.g., motor 450 can be internal to housing 125 and having an output immediately coupled to drive output 456B). Additionally, it is noted that one or more disclosed processes can be combined into a single process providing aggregate functionality. Still further, components of disclosed machines/devices/motors can also interact with one or more other components not specifically described herein but known by those of skill in the art.

In regard to the various functions performed by the above described components, machines, apparatuses, devices, processes, control operations and the like, the terms (including a reference to a “means”) used to describe such components, etc., are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as mechanical structures, mechanical drives, hydraulic or hydrostatic structures, electronic or electro-mechanical drive controllers, and electronic hardware configured to implement the functions, or a computer-readable medium having computer-executable instructions for performing the acts or events of the various processes or control operations described herein.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be construed as being limited to those illustrations. Rather, any suitable combination or subset of elements from one drawing(s) can be applied to other embodiments in other drawings where suitable to one of ordinary skill in the art to accomplish objectives disclosed herein, objectives known in the art, or objectives and operation reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An apparatus, comprising:
a housing that defines an exterior surface of at least a portion of the apparatus;
an intake interface of the housing that defines an opening in the housing and is shaped to abut a discharge port of a mow deck of a mowing machine;
a fastener configured to mechanically couple the apparatus to the mowing machine to resist movement of the opening away from the ejection port;
a driven element configured to be driven to move within the housing, the driven element extending from the intake interface of the housing to an output of the housing and wherein the driven element moves about an axis that is non-parallel with a line between the intake interface of the housing and the output of the housing;
a surface adjacent to the driven element and extending from a first end proximate to the opening in the housing to a second end proximate to the output of the housing; and
at least one actuator secured to the driven element and movable in conjunction with the driven element relative to the surface, wherein each actuator of the at least one actuator has an associated length that extends partway between the driven element and the surface, and wherein the at least one actuator is configured to transfer momentum from the at least one actuator to material within the housing in response to movement of the driven element within the housing.

2. The apparatus of claim 1, wherein a first actuator of the at least one actuator is a rigid or semi-rigid structure extending partway between the driven element and the surface and configured to move the material at least partway along the surface in response to the movement of the driven element within the housing.

3. The apparatus of claim 1, wherein a second actuator of the at least one actuator is a non-rigid structure covering a first distance from the driven element to the surface when extended and covering a second distance from the driven element to the surface when not extended, wherein the second distance is shorter than the first distance.

4. The apparatus of claim 1, wherein the driven element comprises a continuous structure that extends from the intake interface of the housing to the output and rotates about an axis perpendicular to or substantially perpendicular to the line between the intake interface of the housing and the output.

5. The apparatus of claim 4, wherein the driven element comprises at least one belt, chain, rope, string, cord or strap, or a combination of the foregoing, that rotates about the axis perpendicular to or substantially perpendicular to the line between the intake interface of the housing and the output and is configured to drive the at least one actuator from the intake interface of the housing to the output to transfer material received from the discharge port of the mowing machine at the intake interface output of the housing and eject the material from the apparatus at the output of the housing.

6. The apparatus of claim 1, wherein the driven element comprises multiple structures that respectively extend a portion of a distance from the intake interface of the housing to the output and that propel the matter along the surface consecutively from a first of the multiple structures proximate to the intake interface of the housing to a last of the multiple structures proximate to the output, thereby receiving the matter from the mow deck at the intake interface of the housing and expelling the matter from the housing at the output.

7. The apparatus of claim 1, wherein the surface is a floor underlying the driven element, and wherein the floor is formed from the housing or secured to the housing beneath the driven element.

8. The apparatus of claim 1,
wherein the at least one actuator comprises a plurality of actuators secured to the driven element and spaced along a direction, and
wherein the apparatus further comprises an actuator guide that physically separates the respective actuators of the plurality of actuators along the direction according to one or more spacings between the respective actuators defined by the actuator guide.

9. The apparatus of claim 8, wherein the actuator guide is positioned in front of the intake interface of the housing near a forward-most portion of the housing and a rear of the actuator guide defines a surface curvature that redirects the material received from the mowing machine from an ejection direction defined by the discharge port of the mow deck toward a transfer direction that extends along a length of the housing and upward from the intake interface of the housing toward the output of the housing.

10. The apparatus of claim 9, wherein the actuator guide separates the respective actuators according to the fixed spacing as the actuators exit the rear of the actuator guide and physically interact with the material received from the mowing machine in response to movement of the driven element.

11. The apparatus of claim 8, wherein the intake interface of the housing is located at a front of the housing and the output of the housing is located at a rear of the housing opposite the front of the housing.

12. The apparatus of claim 11, wherein the actuator guide is positioned above at least a portion of the driven element.

13. The apparatus of claim 12, wherein the actuator guide is positioned proximate to and above the intake interface of the housing near a forward-most portion of the housing.

14. The apparatus of claim 1, further comprising a material ejector that comprises an ejector housing configured to receive the material from the output of the housing via an input interface of the material ejector and to expel the material via an output port of the material ejector, wherein the input interface of the material ejector is in a first plane and the output port is in a second plane distinct from the first plane.

15. The apparatus of claim 14, wherein the material ejector comprises a rotatable implement configured to rotate within the ejector housing around an axis of rotation that is substantially perpendicular to the first plane, wherein the rotatable implement is configured to expel at least a first portion of the material.

16. The apparatus of claim 14, wherein the material ejector comprises at least one redirection surface configured to deflect the material from a first direction to a second direction, wherein the first direction is substantially perpendicular to the first plane and the second direction is substantially perpendicular to the first direction.

17. The apparatus of claim 14, wherein the ejector housing is configured to expel the material via the output port of the material ejector to a receptacle for receiving and storing the material.

18. The apparatus of claim 1, further comprising a motor for generating mechanical power having a motor output, wherein the driven element is mechanically coupled to the motor output and movable at least in part within the housing in response to movement of the motor output.

19. A turf maintenance apparatus, comprising:
a mow deck comprising a cutting unit for cutting vegetation beneath the mow deck, the mow deck defining an ejection port from which turf clippings generated by the cutting unit are expelled from the mow deck; and
a conveyor apparatus having an intake port in fluid communication with the ejection port of the mow deck, wherein turf clippings expelled from the ejection port of the mow deck enter the intake port of the conveyor apparatus, and wherein the conveyor apparatus further comprises:
a housing defining exterior surfaces including a deck-side surface in which the intake port defines an opening, wherein the intake port is proximate to a first longitudinal end of the housing;
an output port proximate to a second longitudinal end of the housing;
a bottom surface of the housing underlying the intake port and defining a bottom surface length extending from the intake port to the output port of the housing;
a motor and a motor drive that provides mechanical power in response to operation of the motor; and
a powered element and at least one actuator configured to rotate about an axis of rotation in response to the mechanical power provided by the motor and the motor drive, wherein the powered element causes the at least one actuator to traverse the bottom surface at least partway along the length thereof in a direction from the intake port to the output port.

20. The turf maintenance apparatus of claim 19, wherein the powered element further comprises a continuous length that extends about the axis of rotation and about a second axis of rotation.

21. The turf maintenance apparatus of claim 20, wherein the powered element comprises a plurality of actuators, including the at least one actuator, respectively spaced along the continuous length of the powered element.

22. The turf maintenance apparatus of claim 20, wherein the continuous length comprises a belt, a chain, a cord, or a strap to which the at least one actuator is secured.

23. The turf maintenance apparatus of claim 20, wherein the at least one actuator comprises a plurality of discrete rigid or quasi-rigid actuators spaced across a width of the powered element.

24. The turf maintenance apparatus of claim 23, wherein movement of the powered element drives the at least one actuator along the bottom surface length of the bottom surface to transfer turf clippings received at the intake port of the conveyor apparatus to the output port of the conveyor apparatus.

25. The turf maintenance apparatus of claim 23, further comprising an actuator guide positioned in the path of the actuator, wherein the actuator guide comprises openings spaced at fixed distances along its width that direct respective actuators of the plurality of discrete rigid or quasi-rigid actuators to proper positions along the width of the powered element.

26. The turf maintenance apparatus of claim 25, wherein the actuator guide is positioned on the bottom surface length in front of the intake port and has a rear surface that defines a curvature adjacent the ejection port of the mow deck.

27. The turf maintenance apparatus of claim 26, wherein the curvature of the rear surface receives the turf clippings from the ejection port of the mow deck and wherein the curvature redirects the turf clippings by an angle between substantially fifty degrees and ninety degrees from the intake port along a length of the conveyor apparatus toward the output port.

28. The turf maintenance apparatus of claim 25, wherein the intake port is located at a front of the housing and the output port is located at a rear of the housing opposite the front of the housing.

29. The turf maintenance apparatus of claim 28, wherein the actuator guide is positioned above at least a portion of the powered element.

30. The turf maintenance apparatus of claim 29, wherein the actuator guide is positioned proximate to and above the intake port of the housing near a forward-most portion of the housing.

31. The turf maintenance apparatus of claim 19, further comprising a clipping ejector that comprises an ejector housing configured to receive the turf clippings from the output port via an input interface of the clipping ejector and to expel the turf clippings via an output of the clipping ejector, wherein the input interface of the clipping ejector is in a first plane and the output of the clipping ejector is in a second plane distinct from the first plane.

32. The turf maintenance apparatus of claim 31, wherein the clipping ejector comprises a rotatable implement configured to rotate within the ejector housing around an axis of rotation that is substantially perpendicular to the first plane, wherein the rotatable implement is configured to expel at least a first portion of the turf clippings.

33. The turf maintenance apparatus of claim 31, wherein the clipping ejector comprises at least one redirection surface configured to deflect the turf clippings from a first direction to a second direction, wherein the first direction is substantially perpendicular to the first plane and the second direction is substantially perpendicular to the first direction.

34. The turf maintenance apparatus of claim 31, wherein the ejector housing is configured to expel the material via the output of the clipping ejector to a receptacle for receiving and storing the turf clippings.

35. The turf maintenance apparatus of claim 19, wherein the conveyor apparatus further comprises a motor and a motor drive configured to provide mechanical power in response to operation of the motor, and wherein the powered element and actuator are mechanically coupled to the motor drive that rotates about an axis of rotation in response to the mechanical power provided by the motor and the motor drive.
